SEQUENCE LISTING (13 sequences)

SEQ ID NO: 1 - DNA, 1501 bp, Pseudomonas jessenii P161 strain
tgaacgctggcggcaggcctaacacatgcaagtcgagcggatgacgggagcttgctcctgaattcagcggcggacgggtgagtaatgcctaggaatctgcctggtagtgggggacaacgtctcgaaagggacgctaataccgcatacgtcctacgggagaaagcaggggaccttcgggccttgcgctatcagatgagcctaggtcggattagctagttggtgaggtaatggctcaccaaggcgacgatccgtaactggtctgagaggatgatcagtcacactggaactgagacacggtccagactcctacgggaggcagcagtggggaatattggacaatgggcgaaagcctgatccagccatgccgcgtgtgtgaagaaggtcttcggattgtaaagcactttaagttgggaggaagggcattaacctaatacgttagtgttttgacgttaccgacagaataagcaccggctaactctgtgccagcagccgcggtaatacagagggtgcaagcgttaatcggaattactgggcgtaaagcgcgcgtaggtggtttgttaagttggatgtgaaagccccgggctcaacctgggaactgcattcaaaactgacaagctagagtatggtagagggtggtggaatttcctgtgtagcggtgaaatgcgtagatataggaaggaacaccagtggcgaaggcgaccacctggactgatactgacactgaggtgcgaaagcgtggggagcaaacaggattagataccctggtagtccacgccgtaaacgatgtcaactagccgttgggagccttgagctcttagtggcgcagctaacgcattaagttgaccgcctggggagtacggccgcaaggttaaaactcaaatgaattgacgggggcccgcacaagcggtggagcatgtggtttaattcgaagcaacgcgaagaaccttaccaggccttgacatccaatgaactttccagagatggatgggtgccttcgggaacattgagacaggtgctgcatggctgtcgtcagctcgtgtcgtgagatgttgggttaagtcccgtaacgagcgcaacccttgtccttagttaccagcacgtaatggtgggcactctaaggagactgccggtgacaaaccggaggaaggtggggatgacgtcaagtcatcatggcccttacggcctgggctacacacgtgctacaatggtcggtacagagggttgccaagccgcgaggtggagctaatcccacaaaaccgatcgtagtccggatcgcagtctgcaactcgactgcgtgaagtcggaatcgctagtaatcgcgaatcagaatgtcgcggtgaatacgttcccgggccttgtacacaccgcccgtcacaccatgggagtgggttgcaccagaagtagctagtctaaccttcgggaggacggttaccacggtgtgattcatgactggggtgaagtcgtaccaaggtagccgtaggggaacctgcggctggatcac

SEQ ID NO: 2 - DNA, 20 bp, Artificial
  Primer for PCR multiplication
tgctggaactgatccagtac

SEQ ID NO: 3 - DNA, 23 bp, Artificial
  Primer for PCR multiplication
gggttgaggatgctctggatgtg

SEQ ID NO: 4 - DNA, 1680 bp, Pseudomonas cichorii YN2; FERM P-17411
atgagtaacaagagtaacgatgagttgaagtatcaagcctctgaaaacaccttggggcttaatcctgtcgttgggctgcgtggaaaggatctactggcttctgctcgaatggtgcttaggcaggccatcaagcaaccggtgcacagcgtcaaacatgtcgcgcactttggtcttgaactcaagaacgtactgctgggtaaatccgggctgcaaccgaccagcgatgaccgtcgcttcgccgatccggcctggagccagaacccgctctataaacgttatttgcaaacctacctggcgtggcgcaaggaactccacgactggatcgatgaaagtaacctcgcccccaaggatgtggcgcgtgggcacttcgtgatcaacctcatgaccgaagccatggcgccgaccaacaccgcggccaacccggcggcagtcaaacgctttttcgaaaccggtggcaaaagcctgctcgacggcctctcgcacctggccaaggatctggtacacaacggcggcatgccgagccaggtcaacatgggtgcattcgaggtcggcaagagcctgggcgtgaccgaaggcgcggtggtgtttcgcaacgatgtgctggaactgatccagtacaagccgaccaccgagcaggtatacgaacgcccgctgctggtggtgccgccgcagatcaacaagttctacgttttcgacctgagcccggacaagagcctggcgcggttctgcctgcgcaacaacgtgcaaacgttcatcgtcagctggcgaaatcccaccaaggaacagcgagagtggggcctgtcgacctacatcgaagccctcaaggaagcggttgatgtcgttaccgcgatcaccggcagcaaagacgtgaacatgctcggcgcctgctccggcggcatcacttgcaccgcgctgctgggccattacgcggcgattggcgaaaacaaggtcaacgccctgaccttgctggtgagcgtgcttgataccaccctcgacagcgatgttgccctgttcgtcaatgaacagacccttgaagccgccaagcgccactcgtaccaggccggcgtactggaaggccgcgacatggcgaaggtcttcgcctggatgcgccccaacgatctgatctggaactactgggtcaacaattacctgctaggcaacgaaccgccggtgttcgacatcctgttctggaacaacgacaccacacggttgcccgcggcgttccacggcgacctgatcgaactgttcaaaaataacccactgattcgcccgaatgcactggaagtgtgcggcacccccatcgacctcaagcaggtgacggccgacatcttttccctggccggcaccaacgaccacatcaccccgtggaagtcctgctacaagtcggcgcaactgtttggcggcaacgttgaattcgtgctgtcgagcagcgggcatatccagagcatcctgaacccgccgggcaatccgaaatcgcgctacatgaccagcaccgaagtggcggaaaatgccgatgaatggcaagcgaatgccaccaagcataccgattcctggtggctgcactggcaggcctggcaggcccaacgctcgggcgagctgaaaaagtccccgacaaaactgggcagcaaggcgtatccggcaggtgaagcggcgccaggcacgtacgtgcacgaacggtaa

SEQ ID NO: 5 - DNA, 1683 bp, Pseudomonas cichorii YN2; FERM P-17411
atgcgcgataaacctgcgagggagtcactacccacccccgccaagttcatcaacgcacaaagtgcgattaccggcctgcgtggccgggatctggtttcgactttgcgcagtgtcgccgcccatggcctgcgccaccccgtgcacaccgcgcgacacgccttgaaactgggtggtcaactgggacgcgtgttgctgggcgacaccctgcatcccaccaacccgcaagaccgtcgcttcgacgatccggcgtggagtctcaatcccttttatcgtcgcagcctgcaggcgtacctgagctggcagaagcaggtcaagagctggatcgacgaaagcaacatgagcccggatgaccgcgcccgtgcgcacttcgcgttcgccctgctcaacgatgccgtgtcgccgtccaacagcctgctcaatccgctggcgatcaaggaaatcttcaactccggcggcaacagcctggtgcgcgggatcggccatctggtcgatgacctcttgcacaacgatggcttgccccggcaagtcaccaggcatgcattcgaggttggcaagaccgtcgccaccaccaccggcgccgtggtgtttcgcaacgagctgctggagctgatccaatacaagccgatgagcgaaaagcagtattccaaaccgctgctggtggtgccgccacagatcaacaagtactacatttttgacctcagcccccataacagcttcgtccagttcgcgctcaagaacggcctgcaaaccttcgtcatcagctggcgcaatccggatgtacgtcaccgcgaatggggcctgtcgacctacgtcgaagcggtggaagaagccatgaatgtctgccgggcaatcaccggcgcgcgcgaggtcaacctgatgggcgcctgcgctggcgggctgaccattgctgccctgcagggccacttgcaagccaagcgacagctgcgccgcgtctccagcgcgacgtacctggtgagcctgctcgacagccaactggacagcccggccacactcttcgccgacgaacagaccctggaggcggccaagcgccgctcctaccagaaaggtgtgctggaaggccgcgacatggccaaggttttcgcctggatgcgccccaacgatttgatctggagctacttcgtcaacaattacctgatgggcaaggagccgccggcgttcgacattctctactggaacaatgacaacacacgcctgccggccgccctgcatggtgacttgctggacttcttcaagcacaacccgctgagccatccgggtggcctggaagtgtgcggcaccccgatcgacttgcaaaaggtcaccgtcgacagtttcagcgtggccggcatcaacgatcacatcacgccgtgggacgcggtgtatcgctcaaccctgttgctcggtggcgagcgtcgctttgtcctggccaacagcggtcatgtgcagagcattctcaacccgccgaacaatccgaaagccaactacctcgaaggtgcaaaactaagcagcgaccccagggcctggtactacgacgccaagcccgtcgacggtagctggtggacgcaatggctgggctggattcaggagcgctcgggcgcgcaaaaagaaacccacatggccctcggcaatcagaattatccaccgatggaggcggcgcccgggacttacgtgcgcgtgcgctga

SEQ ID NO: 6 - DNA, 29 bp, Artificial
  Primer for PCR multiplication
ggaccaagcttctcgtctcagggcaatgg

SEQ ID NO: 7 - DNA, 29 bp, Artificial
  Primer for PCR multiplication
cgagcaagcttgctcctacaggtgaaggc

SEQ ID NO: 8 - DNA, 29 bp, Artificial
  Primer for PCR multiplication
gtattaagcttgaagacgaaggagtgttg

SEQ ID NO: 9 - DNA, 30 bp, Artificial
  Primer for PCR multiplication
catccaagcttcttatgatcgggtcatgcc

SEQ ID NO: 10 - DNA, 30 bp, Artificial
  Primer for PCR multiplication
cgggatccagtaacaagagtaacgatgagt

SEQ ID NO: 11 - DNA, 30 bp, Artificial
  Primer for PCR multiplication
cgatctcgagttaccgttcgtgcacgtacg

SEQ ID NO: 12 - DNA, 30 bp, Artificial
  Primer for PCR multiplication
cgggatcccgcgataaacctgcgagggagt

SEQ ID NO: 13 - DNA, 30 bp, Artificial
  Primer for PCR multiplication
cgatctcgaggcgcacgcgcacgtaagtcc

(19) United States
(12) Patent Application Publication
(10) Pub. No.: US 2007/0027291 A1
(43) Pub. Date: Feb. 1, 2007

(54) Structure and method for producing structure, toner containing structure, image forming method and device using toner

(76) Inventors: Tetsuya Yano, TOKYO (JP); Tsuyoshi Nomoto, Komae-shi, Tokyo (JP); Shinya Kozaki, Tokyo (JP); Takeshi Imamura, Chigasaki-shi, Kanagawa-ken (JP); Tsutomu Honma, Atsugi-shi, Kanagawa (JP)

Correspondence Address: FITZPATRICK CELLA HARPER & SCINTO, 30 ROCKEFELLER PLAZA, NEW YORK, NY, 10112, US

(21) Appl. No.: 10/534,040

(22) PCT Filed: Apr. 30, 2004
(86) PCT No.: PCT/JP04/06349

§ 371 Date: May 6, 2005

(30) Foreign Application Priority Data
May 2, 2003 (JP) 2003-127508

(51) Int. Cl. G03G 9/00; C08G 67/00; C08G 63/00; C08G 69/00

(52) U.S. Cl. 528/271; 430/109.4

(57) ABSTRACT

A structure, comprising a base material, coated with polymer which can be compatible with reduced load against environment and living organisms and various functionalities is provided. The base material is covered with polyhydroxyalkanoate (PHA). The invention also relates to a method for production of the structure comprising immobilizing the enzyme which synthesize PHA on the surface of the base material, biosynthesizing the PHA and coating the base material. The invention also provides toner containing such the structure and production thereof. Further, the invention relates to an image forming method comprising forming the image by providing such toner to the medium to be recorded.

### TECHNICAL FIELD

The present invention relates to a structure comprising a polyhydroxyalkanoate and base material and having a structure with the base material coated, at least partly, with the polyhydroxyalkanoate, and a method for producing the same.

### BACKGROUND ART

Polymeric materials are essential to modern industries and our lives. The materials, which are inexpensive and lightweight and have good moldability, are widely utilized as packaging material and cushioning material or the like, or fiber material, as well as boxes for household electrical appliances. On the other hand, diverse functional materials such as a liquid crystal material and a coat agent are also obtained by utilizing stable properties of these polymeric materials to thereby place substituents of exhibiting various functions on molecular chains of the polymers. These functional materials are higher in added values than polymers for structural materials and thus can be expected to have large market needs even in a small amount. These functional polymeric materials have been produced so far by organic, synthetic chemical methods in synthetic processes of polymers or by modifying synthesized polymers with substituents. Polymers of basic frameworks for functional polymeric materials have been obtained from petroleum based raw material by organic, synthetic chemical methods in most cases. Typical examples of these polymers include polyethylene, poly(ethylene terephthalate), polyesters, polystyrene, poly(vinyl chloride) and polyacrylamides.

Incidentally, the present inventors have focused on a multilayered structure, the base material of the structures being coated with a polymeric compound, as a basic element that imparts large added values to the polymeric compound. A composite structure of extremely useful functionality can be obtained by coating a specific base material with a polymeric compound as described above. The specific purposes of the structure include capsule toner for electrophotography, composed of a microcapsule structure with the toner component encased in, e.g., a high-molecular-weight compound, and recording medium for ink jet recording with a sheet-shaped base material coated with a high-molecular-weight compound.

Electrophotography generally produces copied images by forming an electrical latent image on a photoreceptor using a photoconductive material by various means, developing the latent image with a toner, transferring, as required, the toner image to a medium, e.g., paper, and fixing the image with the aid of heat or/and pressure, solvent vapor, or the like. The toner for the above purposes has been traditionally a “crushed toner” of a composition with a colorant composed of a dye or pigment fused to be uniformly dispersed in a thermoplastic resin, and crushed and classified to have a desired particle size. The toner, although exhibiting excellent functions, involves problems, e.g., the toner materials being selected from a limited range, because they are required to be brittle by the production system. Japanese Patent Publication No. S36-10231 (Patent Document) discloses a “polymerized toner” produced by suspension polymerization as one of the proposals to solve these problems. The suspension polymerization method produces an intended toner by uniformly dissolving or dispersing a polymerizable monomer, colorant, polymerization initiator, and, as required, crosslinking agent or charge controlling agent, and then polymerizing the monomer in a continuous phase (e.g., aqueous phase) containing a dispersion stabilizer in which the above mixture is dispersed with stirring. This method can use a soft material as one of its advantages, because it involves no crushing step and hence requires no toner of brittleness. However, the polymerized toner of very small particle size involves problems, e.g., its properties tending to be adversely affected by the colorant, because the colorant and charge controlling agent are easily exposed to the toner surface layer, and anticipated deterioration in charging uniformity. The so-called “capsule toner” with the polymer particle surfaces coated with one or more layers of a high-molecular-weight compound has been proposed to solve these problems.

Japanese Patent Application Laid-Open No. H8-286416 discloses a capsule toner with polymer particles coated with a polar resin for static development and method for producing the same. This method involves a chemical procedure of organic synthesis to coat polymer particles containing a toner component, where each particle serves as a core. It can provide an excellent capsule toner for static development which realizes improved image durability, and uniform and stabilized charging by solving the above problems. Japanese Patent Application Laid-Open No. H9-292735 discloses an image-forming capsule toner comprising a core of releasing agent material and another material of high thermal expansion coefficient, coated with a firm resin. The toner is of a functional microcapsule designed in such a way that the thermally expandable material in the core expands under heating during the fixation step to destroy the coating and pushing the releasing agent material included in the core outwards. It is expected to exhibit good fixation characteristics, e.g., causing no off-set when a film-heating type fixation unit is used, and fixing at a low pressure while helping keep the printing medium smooth when a roller type fixation unit is used. Similarly, capsule toners coated with a high-molecular-weight compound and their production methods are disclosed by Japanese Patent Application Laid-Open Nos. H5-119531, H5-249725, H6-332225, H9-43896, H10-78676, H11-7163, 2000-66444, 2000-112174 and 2000-330321. These methods produce an intended capsule structure by chemical procedure of organic synthesis, e.g., suspension, emulsion, precipitation, dispersion, soap-free emulsion or seed polymerization.

However, these methods involve problems, e.g., very complex production steps required, and large quantities of solvents or surfactants required by the production steps.

Recording media of laminated structure with a sheet-shaped base material coated with a high-molecular-weight compound include those for ink jet printing, for example. Ink jet printing discharges, based on varying working principles, very fine ink droplets onto a recording medium, e.g., paper, to print images, letters and the like thereon. The ink contains a large quantity of solvent, e.g., water or a mixture of water and organic solvent. Therefore, a large quantity of the ink is required to secure a high color concentration. The ink droplets are discharged continuously, and the droplets, once discharged, fuse with each other to cause a beading phenomenon by which the ink dots are connected to each other to disarrange the images formed on a medium. Therefore, media for ink jet recording are required to absorb a large quantity of ink quickly.

Therefore, a recording medium in which an ink-receiving layer is formed on the base material to accelerate ink absorption has been proposed. Japanese Patent Application Laid-Open No. S55-146786 proposes a recording medium whose base material is coated with a water-soluble resin, e.g., polyvinyl alcohol or polyvinyl pyrrolidone. Japanese Patent Application Laid-Open No. H5-221112 proposes a recording medium which incorporates a water-resistant resin. Moreover, recording media incorporating an ionic resin for the ink-receiving layer have been proposed by Japanese Patent Application Laid-Open No. H11-78221 and Japanese Patent Application Laid-Open No. 2000-190631. They are excellent in wettability with water, water resistance, dye fixing characteristics, and ink absorption and drying, to give clear images thereon.

The ink-receiving layer is generally formed on a base material by coating, e.g., blade, air knife, roll, flash, gravure, kiss, die, extrusion, slide hopper, curtain or spray coating.

A high-molecular-weight compound for coating a base material is synthesized and structureed by an organic synthesis procedure, when any of the above coating methods is employed. It is provided with various functions.

[PHA]

Recently, bioengineering procedures have been extensively studied to produce high-molecular-weight compounds, some of which have been already commercialized. For example, microbe-derived high-molecular-weight compounds include polyhydroxyalkanoates (hereinafter sometimes referred to as PHAs), e.g., poly-3-hydroxy-n-butyric acid (hereinafter sometimes referred to as PHB) and copolymer of 3-hydroxy-n-butyric acid and 3-hydroxy-n-valeric acid (hereinafter sometimes referred to as PHB/V); polysaccharides, e.g., bacteria cellulose and pullulan; and polyamino acids, e.g., poly-γ-glutamic acid and polylysine. PHA, in particular, is expected to go into soft materials for medical purposes, because they can be processed by fusing into various products like conventional plastic materials, and are compatible with a living body.

A number of microbes have been reported to produce and hold PHAs. Production of PHB/Vs by microbes, e.g., Alcaligenes eutrophus H16, ATCC No. 17699, Methylobacterium sp., Paracoccus sp., Alcaligenes sp. or Pseudomonas sp. has been disclosed by Japanese Patent Application Laid-Open No. H5-74492, and Japanese Patent Publication Nos. H6-15604, H7-14352 and H8-19227. It is also disclosed that Comamonas acidovorans IFO13852 produces a PHA having a 3-hydroxy-n-butyric acid and 4-hydroxy-n-butyric acid monomers (Japanese Patent Application Laid-Open No. H9-191893), and that Aeromonas caviae produces a copolymer of 3-hydroxy-n-butyric acid and 3-hydroxy-hexanoic acid.

The bissynthesis of PHB or PHB/V is achieved by enzymatic polymerization of (R)-3-hydroxybutyryl-CoA or (R)-3-hydroxyvaleryl-CoA as a substrate, which is produced from varying carbon sources via various metabolisc pathways in a living body. The enzyme which catalyzes the polymerization is referred to as PHB polymerase (or synthase). CoA is an abbreviation of coenzyme A having the following chemical structure.

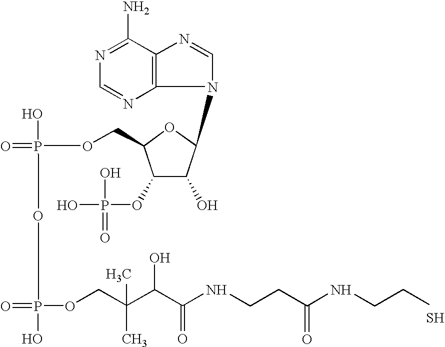

Recently, polyhydroxyalkanoates composed of 3-hydroxyalkanoate unit of medium chain length (carbon number: 3 to 12 or so), hereinafter sometimes referred to as mcl-PHAs, have been extensively studied.

Japanese Patent No. 2642937 discloses that a PHA having a 3-hydroxyalkanoic acid monomer unit of 6 to 12 carbon atoms can be produced by introducing a non-cyclic aliphatic hydrocarbon into Pseudomonas oleovorans ATCC 29347. It is reported in Appl. Environ. Microbiol., 58, 746, 1992 that Pseudomonas resinovorans produces a PHA having 3-hydroxy-n-butyric acid, 3-hydroxy-hexanoic acid, 3-hydroxyoctanoic acid or 3-hydroxydecanoic acid as a monomer from octanoic acid as the sole carbon source, and that the same microbe also produces a PHA having 3-hydroxy-n-butyric acid, 3-hydroxy-hexanoic acid, 3-hydroxyoctanoic acid or 3-hydroxydecanoic acid as a monomer unit from hexanoic acid as the sole carbon source. It is considered that introduction of a 3-hydroxyalkanoic acid monomer unit having a longer chain than the starting fatty acid is via a fatty acid synthesis route, described later.

It is also reported in Int. Biol. Macromol., 16(3), 119, 1994 that Pseudomonas sp. Strain 61-3, produces a PHA having 3-hydroxyalkanoic or 3-hydroxyalkenoic acid as a monomer unit from sodium gluconate acid as the sole carbon source, where the 3-hydroxyalkanoic acids include 3-hydroxy-n-butyric acid, 3-hydroxy-hexanoic acid, 3-hydroxyoctanoic acid and 3, and 3-hydroxyalkenoic acids include 3-hydroxy-5-cis-decenoic acid and 3-hydroxy-5-cis-dodecenoic acid.

Each of the above PHAs is the one composed of a monomer unit with an alkyl group in the side chain (hereinafter sometimes referred to as usual-PHA) or a similar one (e.g., additionally having an alkenyl group in a side chain at a position other than terminal). However, PHAs having a substituent other than alkyl group (e.g., phenyl, unsaturated hydrocarbon, ester, allyl, cyano, halogenated hydrocarbon or epoxide group) in the side chain (hereinafter sometimes referred to as unusual PHAs) are very useful, when their application to a wider area, e.g., application to functional polymers, is considered.

For biosynthesis of an unusual PHA having phenyl group, Macromolecules, 24, 5256-5260, 1991, Macromol. Chem., 191, 1957-1965, 1990 and Chirality, 3, 492-494, 1991 report that Pseudomonas oleovorans produces a PHA having a 3-hydroxy-5-phenylvalerate unit from 5-phenylvaleric acid. Macromolecules, 29, 1762-1766, 1996 reports that Pseudomonas oleovorans produces a PHA having a 3-hydroxy-5-(4-tolyl)valerate unit from 5-(4-tolyl)valeric acid (5-(4-methylphenyl)valeric acid). Macromolecules, 32, 2889-2895, 1999 reports that Pseudomonas oleovorans produces a PHA having a 3-hydroxy-5-(2,4-dinitrophenyl)valeric acid and 3-hydroxy-5-(4-nitrophenyl)valerate units from 5-(2,4-dinitrophenyl)valeric acid.

For synthesis of an unusual PHA having phenoxy group, Macromol. Chem. Phys. 195, 1665-1672, 1994 reports that Pseudomonas oleovorans produces that a PHA having a 3-hydroxy-5-phenoxyvaleric acid and 3-hydroxy-9-phenoxynonanic acid units from 11-phenoxyundecanoic acid Macromolecules, 29, 3432-3435, 1996 reports that Pseudomonas oleovorans produces a PHA having a 3-hydroxy-4-phenoxybutyric acid and 3-hydroxy-6-phenoxyhexanoate units from 6-phenoxyhexanoic acid, PHA having a 3-hydroxy-4-phenoxybutyric acid, 3-hydroxy-6-phenoxyhexanoic acid and 3-hydroxy-8-phenoxyoctanoate units from 8-phenoxyoctanoic acid, and PHA having a 3-hydroxy-5-phenoxyvaleric acid and 3-hydroxy-7-phenoxyheptanoate units from 11-phenoxyundecanoic acid. Moreover, Can. J. Microbiol., 41, 32-43, 1995 reports that Pseudomonas oleovorans ATCC 29347 or Pseudomonas putida KT2442 produces a PHA having a 3-hydroxy-p-cyanophenoxyhexanoic acid or 3-hydroxy-p-nitrophenoxyhexanoate unit from p-cyanophenoxyhexanoic acid or p-nitrophenoxyhexanoic acids. Japanese Patent No. 2989175 discloses a homopolymer composed of a 3-hydroxy-5-(monofluorophenoxy)valeric acid or 3-hydroxy-5-(difluorophenoxy)valerate unit, and a copolymer at least containing 3-hydroxy-5-(monofluorophenoxy)pentanoate or 3-hydroxy-5-(difluorophenoxy)pentanoate unit, and their production methods, mentioning that they can provide the polymers with steric regularity and water repellency while keeping a high melting point and good processability.

For synthesis of an unusual PHA having cyclohexyl group, phenoxy group, Macromolecules, 30, 1611-1615, 1997 reports that Pseudomonas oleovorans produces the PHA from cyclohexyl butyric or valeric acid.

[A Mechanism of PHA Synthesis]

The biosynthesis of the mcl PHA and the unusual PHA is carried out through a polymerization reaction by an enzyme using as a substrate (R)-3-hydroxyacyl CoA produced from alkanoic acids as a substrate by way of various metabolic pathways in an organism (e.g. β-oxidation system and fatty acid synthesis pathway). It is a PHA synthesizing enzyme (also referred to as PHA polymerase, PHA synthase) that catalyses this polymerization reaction.

A reaction by which PHA is produced from alkanoic acid through a polymerization reaction by a β-oxidation system and a PHA synthesizing enzyme is shown in the following:

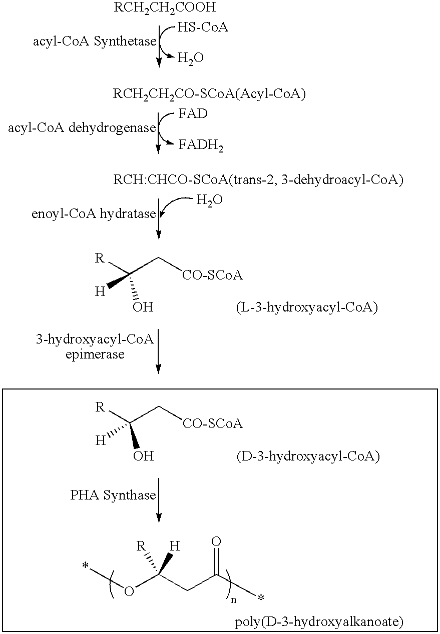

On the other hand, if the reaction is carried out by way of the fatty acid synthesis pathway, it can be considered that PHA is similarly synthesized by the PHA synthesizing enzyme using as a substrate (R)-3-hydroxyacyl CoA into which (R)-3-hydroxyacyl-ACP (ACP means an acyl carrier protein) produced in the pathway has been converted.

In recent years, it has been attempted to take out the above described PHB synthesizing enzyme and PHA synthesizing enzyme from the cell to synthesize PHA in a cell-free system (in vitro). Specific examples thereof will be described below.

For example, in Proc. Natl. Acad. Sci. USA, 92, 6279-6283 (1995), it is reported that PHB comprising a 3-hydroxy-n-butanoic acid unit has been successfully synthesized by making 3-hydroxybutyryl CoA act on a PHB synthesizing enzyme derived from Alcaligenes eutrophus. In addition, it is reported in Int. J. Biol. Macromol., 25, 55-60 (1999) that PHA comprising a 3-hydroxy-n-butyryl acid unit or a 3-hydroxy-n-valeric acid unit has been successfully synthesized by making 3-hydroxybutyryl CoA and 3-hydroxyvaleryl CoA act on the PHB synthesizing enzyme derived from Alcaligenes eutrophus. In addition, according to this report, when racemic 3-hydroxybutyryl CoA was made to act on the enzyme, PHB comprising only a 3-hydroxy-n-butyric acid unit of R-configuration was synthesized due to the stereoselectivity of the enzyme. Synthesis of PHB outside the cell using a PHB synthesizing enzyme derived from Alcaligenes eutrophus is also reported in Macromol. Rapid Commun., 21, 77-84 (2000). In addition, it is reported in FEMS Microbiol. Lett., 168, 319-324 (1998) that PHB comprising a 3-hydroxy-n-butyric unit has been successfully synthesized by making 3-hydrozybutyryl CoA act on a PHB synthesizing enzyme derived from Chromatium vinosum. It is reported in Appl. Microbiol. Biotechnol., 54, 37-43 (2000) that PHA comprising a 3-hydroxydecanoic acid unit has been synthesized by making 3-hydroxydecanoyl CoA act on a PHA synthesizing enzyme from Pseudomonas aeruginosa.

As discussed above, application of bioengineering approaches to polymeric compounds will be able to synthesize new polymeric compounds that are difficult to synthesize by conventional organic synthetic methods and provide new functions and structures. In addition, although conventional, organic, synthetic chemical methods requires a manufacturing step of many stages, the bioengineering method needs only a one-stage step in many cases and therefore is expected to simplify the manufacturing step, save costs and shorten the turnaround time. Further, the method makes it possible to decrease the use of organic solvents, acids and alkalis, surfactants, etc., set mild reaction conditions and synthesize a target material from nonpetroeum-based raw material and low purity raw material, thereby being able to realize a synthetic process of a lower environmental load and a resource recycling type. Additionally, for more detailed description of the synthesis of the low purity raw material, the bioengineering synthetic process generally has a high substrate specificity of an enzyme, or a catalyst, which permits a target reaction to selectively proceed even though a material of a low purity is used, thus enabling the use of waste and recycling raw material.

On the other hand, as described previously, the present inventors have focused attention on a structure made by coating a base material with a polymeric compound as an element for imparting a large added value to the polymeric compound. Coating a specific base material with a polymeric compound like this can provide a composite structure having extremely useful functionality. Although production of the structure described above has conventionally attempted mostly with techniques of organic synthesis, these techniques have limitations.

If this type of structure can be produced by a bioengineering approach as previously mentioned, utilization of a novel polymeric compound that is difficult to produce by a conventional organic synthetic method or new additions of functions and structures will be made possible and thereby a manufacturing process of a lower environmental load and resource recycling type will be realized at a low cost. For example, use of extremely precise molecule recognition ability and stereo selectivity that are specific in catalytic action of living organisms can produce by a simple and easy process of a lower environmental load a novel polymeric compound of functionality that is difficult to produce by a conventional organic synthetic chemical method, or a capsule structure or laminated structure that is coated with an extremely high chirality polymeric compound.

Therefore, the present invention provides a polymeric compound structure of high functionality that can be produced by a bioengineering approach. In addition, the present invention provides an effective manufacturing method of a structure, the base material of which is coated with a polymeric compound, that can be widely utilized as a composite structure of functionality.

### DISCLOSURE OF THE INVENTION

In order to achieve the above problems, as a result of extensive studies, we have found that a structure, in which a base material was covered with PHA, could be obtained by immobilizing PHA synthetase on the surface of the base material and by adding 3-hydroxyacyl CoA thereto to initiate reaction, and have completed the present invention. Further, we have found that the structure with improved various characteristics could be obtained by chemical modification of the PHA. More particularly, we have found that, for example, as a result of introducing a graft chain into the PHA, the structure, in which the base material was at least partially covered by PHA having various characteristics provided by the graft chain, could be obtained. Further, we have found that as a result of crosslinking the PHA, the structure, in which the base material was at least partially covered by PHA having desired physicochemical properties (e.g. mechanical strength, chemical resistance, heat resistance, etc.), could be obtained. Chemical modification in the present invention means to modify a molecular structure of the polymer material by performing intramolecular or intermolecular chemical reaction within the polymer material, or performing chemical reaction between the polymer material and the other chemical substance. Crosslinking means to structure a network structure by bonding chemically or physicochemically with the intermolecular or intramolecular structure of the polymer material. Crosslinking agent means a substance, which is added to perform the above crosslinking reaction and has a definite reactivity with the polymer material.

The present invention relates to the structure comprising at least partially covering the base material with polyhydroxyalkanoate containing 3-hydroxyalkanoate unit.

Further, the present invention relates to a process for production of the structure comprising immobilizing a medium or a long chain polyhydroxyalkanoate synthetase on the surface of the base material, polymerizing 3-hydroxyacyl CoA by said enzyme to synthesize polyhydroxyalkanoate, and covering at least part of the above base material with polyhydroxyalkanoate.

The present invention further relates to a capsule structure having a core (core material) as the base material and an envelop of mcl-PHA or unusual-PHA. More particularly, the present invention relates to a capsule structure comprising at lest containing coloring agent in the core, the capsule structure comprising at lest containing pigment in the coloring agent, or the capsule structure comprising the core being the pigment. The present invention further relates to a laminated structure wherein at least a part of filmy base material is covered mcl-PHA or unusual-PHA.

The present invention further relates to a capsulated toner for electrophotograph comprising the capsule structure, or a recording medium comprising the laminated structure.

The present invention further relates to an image forming method and image forming device using the toner.

More particularly, the present invention relates to a structure comprising a base material characterized in that the base material is coated at least partly with a polyhydroxyalkanoate containing at least one monomer unit selected from the group consisting of those represented by one of the chemical formulae [1] to [8]. 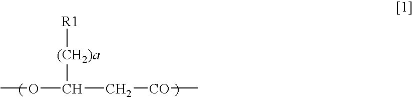
(wherein, the monomer unit is at least one selected from the group consisting of monomer units in which a combination of R1 and “a” is any one of combinations, wherein R1 is vinyl group; and “a” is an integer of 1 to 10), 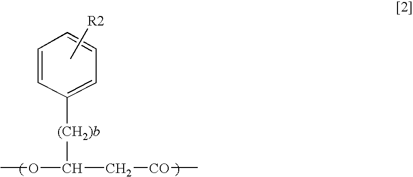
(wherein, “b” is an integer of 1 to 8; and R2 is one selected from the group consisting of CH₃, C₂H₅, C₃H₇, vinyl and epoxy groups, and COOR21 (R21 is H, Na or K atom), which are independently applicable to each unit when there are 2 or more units), 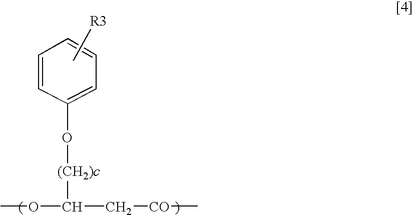
(wherein, “c” is an integer of 1 to 8; and R3 is one selected from the group consisting of CH₃, C₂H₅, C₃H₇ and SCH₃ groups, which are independently applicable to each unit when there are 2 or more units), 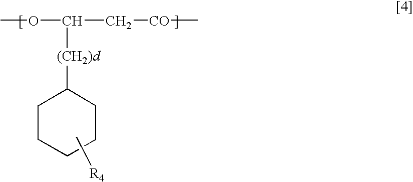
(wherein, “d” is an integer of 0 to 8; and R4 is selected from the group consisting of H and a halogen atoms, and CN, NO₂, CH₃, C₂H₅, C₃H₇, CF₃, C₂F₅ and C₃F₇ groups when “d” is 0, and selected from the group consisting of CH₃, C₂H₅ and C₃H₇ groups when “d” is 1 to 8, which are independently applicable to each unit when there are 2 or more units), 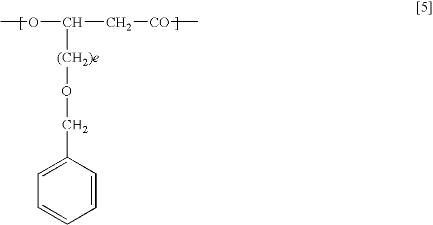
(wherein, “e” is an integer of 1 to 8), 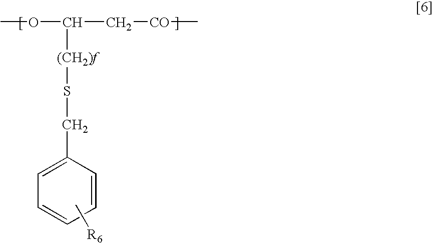
(wherein, “If” is an integer of 1 to 8; and R6 is one selected from the group consisting of CH₃, C₂H₅, C₃H₇, (CH₃)₂—CH and (CH₃)₃—C group, which are independently applicable to each unit when there are 2 or more units), 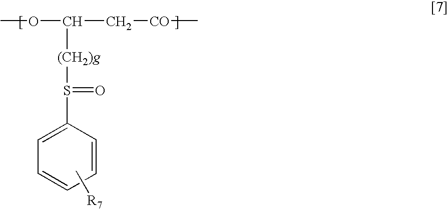
(wherein, “g” is an integer of 1 to 8; and R7 is a H or halogen atom, or CN, NO₂, COOR71 (R71 is H, Na, K, CH₃ or C₂H₅), SO₂R72 (R72 is OH, ONa, OK, a halogen atom, OCH₃ or OC₂H₅), CH₃, C₂H₅, C₃H₇, (CH₃)₂—CH or (CH₃)₃—C group, which are independently applicable to each unit when there are 2 or more units), and 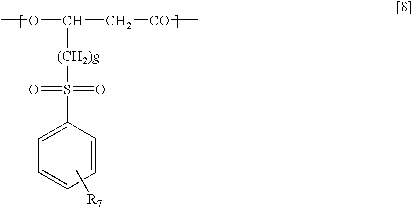
(wherein, “q” is an integer of 1 to 8; and R7 is H or a halogen atom, or CN, NO₂, COOR71 (R71 is H, Na, K, CH₃ or C₂H₅), SO₂R72 (R72 is OH, ONa, OK, a halogen atom, OCH₃ or OC₂H₅), CH₃, C₂H₅, C₃H₇, (CH₃)₂—CH or (CH₃)₃—C group, which are independently applicable to each unit when there are 2 or more units).

The present invention further relates to the method for production of the structure, comprising immobilizing a medium- or long-chain polyhydroxyalkanoate synthetase on the surface of the base material, polymerizing 3-hydroxyacyl CoA by said enzyme to synthesize polyhydroxyalkanoate, and covering at least part of the above base material with polyhydroxyalkanoate, wherein the structure is produced by oxidative reaction of the vinyl group in the structure covered with polyhydroxyalkanoate at least containing a unit, wherein R2 is vinyl group in the structure of the chemical formula [2], in the case that the polyhydroxyalkanoate contains at least any of units selected from the group consisting of epoxy group and COOR21 (wherein R21 represents any of H, Na and K) in R2 in the chemical structure [2), or by oxidative reaction of the substituted or unsubstituted phenylthio group in the structure covered with polyhydroxyalkanoate at least containing a unit, which has substituted or unsubstituted phenylthio group represented by the chemical formula [16] obtained by polymerization in the system containing at least 3-hydroxyacyl CoA represented in the chemical formula [15], in the case that the polyhydroxyalkanoate contains at least any of unit selected from the group consisting of the structure of the chemical formula [7] and [8], with the proviso that the polyhydroxyalkanoate is the polyhydroxyalkanoate which contains at least one selected from the group consisting of the monomer unit shown in the chemical structure (1] to [8], and 3-hydroxyacyl CoA corresponding to any of the unit is the 3-hydroxyacyl CoA shown in the chemical structure [9] to [15]. 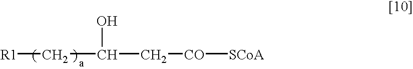
(wherein, —SCoA is a coenzyme A bound to an alkanoic acid; “a” is an integer of 1 to 10, corresponding to “a” in the monomer unit represented by the formula [1]; and R1 is vinyl group), 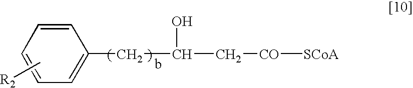
(wherein, —SCoA is a coenzyme A bound to an alkanoic acid; “b” is an integer of 1 to 8, corresponding to “b” in the monomer unit represented by the formula [2]; and R2 is one selected from the.group consisting of CH₃, C₂H₅, C₃H₇ and vinyl groups, corresponding to R2 in the monomer unit represented by the formula [2], 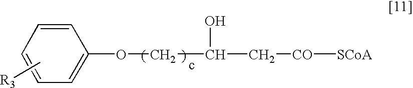
(wherein, —SCoA is a coenzyme A bound to an alkanoic acid; “c” is an integer of 1 to 8, corresponding to “c” in the monomer unit represented by the formula [3]; and R3 is one selected from the group consisting of CH₃, C₂H₅, C₃H₇ and SCH₃ groups, corresponding to R3 in the monomer unit represented by the formula [3], 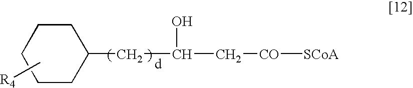
(wherein, —SCoA is a coenzyme A bound to an alkanoic acid; “d” is an integer of 0 to 8, corresponding to “d” in the monomer unit represented by the formula [4]; and R4 is from the group consisting of H and halogen atoms, and CN, NO₂, CH₃, C₂H₅, C₃H₇, CF₃, C₂F₅ and C₃F₇ groups when “d” is 0, and one selected from the group consisting of CH₃, C₂H₅ and C₃H₇ groups when “d” is 1 to 8, corresponding to R4 in the monomer unit represented by the formula [4], 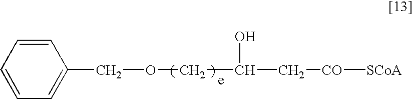
(wherein, —SCoA is a coenzyme A bound to an alkanoic acid; “e” is an integer of 1 to 8, corresponding to “e” in the monomer unit represented by the formula [5], 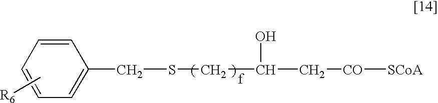
(wherein, —SCoA is a coenzyme A bound to an alkanoic acid; “f” is an integer of 1 to 8, corresponding to “f” in the monomer unit represented by the formula [6]; and R6 is one selected from the group consisting of CH₃, C₂H₅, C₃H₇, (CH₃)₂—CH and (CH₃)₃—C group, corresponding to R6 in the monomer unit represented by the formula [6], 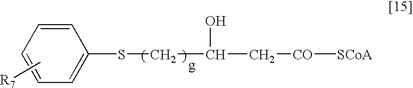
(wherein, —SCoA is a coenzyme A bound to an alkanoic acid; “g” is an integer of 1 to 8, corresponding to “g” in the monomer unit represented by one of the formulae [7] and [8]; and R7 is one selected from the group consisting of H and halogen atoms, and CN, NO₂, COOR71 (R71 is H, Na, K, CH₃ or C₂H₅), SO₂R72 (R72 is OH, ONa, OK, a halogen atom, OCH₃ or OC₂H₅), CH₃, C₂H₅, C₃H₇, (CH₃)₂—CH and (CH₃)₃—C groups, corresponding to R7 in the monomer unit represented by formulae [7] and [8], and 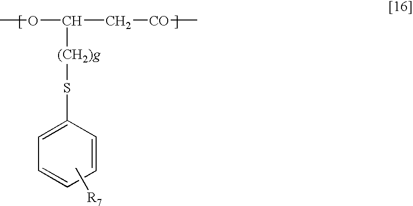
(wherein, “g” is an integer of 1 to 8; and R7 is H or halogen atom, or CN, NO₂, COOR71 (R71 is H, Na, K, CH₃ or C₂H₅), SO₂R72 (R72 is OH, ONa, OK, a halogen atom, OCH₃ or OC₂H₅), CH₃, C₂H₅, C₃H₇, (CH₃)₂—CH or (CH₃)₃—C group, which are independently applicable to each unit when there are 2 or more units).

The present invention also relates to a toner which contains the structure described above.

The present invention further relates to a method for producing a toner comprising the step of producing the structure described above.

The present invention further relates to a method for forming an image by supplying the toner described above onto a recording medium; and a device for forming an image by supplying the toner described above onto a recording medium.

### BEST MODE FOR CARRYING OUT THE INVENTION

The structure of the present invention is the structure having the form covered with the base by PHA containing the monomer unit with various structure having side chains in the substituent, and is extensively useful for high functional structures such as capsulated toner for electrophotograph and recoding media.

The present invention is explained more detail as follows.

<PHA> Examples of PHA used in the present invention are PHA synthesized by PHA synthetase involved in mcl-PHA synthetic reaction (i.e. various mcl-PHA and unusual-PHA). As described in above, PHA synthetase is an enzyme which catalyzes final step in PHA synthetic reaction system in vivo. Consequently, PHA which is known to be synthesized in vivo is synthesized by a catalytic action of said enzyme. Therefore, the structure, in which the base material is covered by PHA which is known to be synthesized in vivo, can be produced by reacting the 3-hydroxyacyl CoA corresponding to the desired PHA with the enzyme immobilized in the base in the present invention.

Examples of such PHA are, concretely, PHA at least containing the monomer unit represented by the chemical formulae [1] to [8].

Examples of PHA used in the present invention can include random copolymer or block copolymer containing plurality of the above monomer unit. Regulation of physical properties of PHA or addition of plurality of functions by applying characteristics of each monomer unit or functions included therein, and expression of new function by applying interaction of functional groups can be made.

Further, monomer unit compositions of PHA can be changed to the direction from the inner side to the outer side, if the shape of the structure is particle, or to the vertical direction, if the shape of the structure is flat, by changing compositions, such as types and concentration, of the substrate 3-hydroxyacyl CoA in time dependent manner.

As a result of such treatments, for example in case of capsule toner, multiple functions such as superior in the anti-blocking property in storing and superior in the fixing property in fixation can be maintained by forming PHA with high glass transition temperature on the surface layer of the toner, and PHA with low glass transition temperature in more inner layer of the toner.

Further, for example, if formation of the covered structure with the base material and the low affinity PHA is required, at first the structure is covered with the base material and the high affinity PHA, and the monomer unit composition of the base material and the high affinity PHA is structureed to the objective monomer unit composition of PHA by changing to the direction from the inner side to the outer side or to the vertical direction, namely, for example, by forming the multiple layer structure or the gradient structure, as a result, the PHA coating strongly bound with the base material can be structureed.

Although 3-hydroxypropionate unit, 3-hydroxy-n-butyrate unit, 3-hydroxy-n-valerate unit, 4-hydroxy-n-butyrate unit, etc. can not be applicable to mcl-PHA or unusual-PHA as the PHA constituted by itself, the PHA, in which such the monomer unit is admixed in the monomer unit hereinbefore exemplified, can be applied in the present invention. Further chemical modification can be made, if necessary, after or during synthesis of PHA. Molecular weight of PHA is preferably in number average molecular weight from 1,000 to 10,000,000, or if said structure is used as capsule toner for electrophotograph, the molecular weight is preferably from 3,000 to 1,000,000.

The PHA synthesized by PHA synthetase used in the structure of the present invention is generally isotactic polymer constituted by R-configuration.

<3-hydroxyacyl CoA>

Example of 3-hydroxyacyl CoA used for substrate of PHA synthetase in the present invention is concretely 3-hydroxyacyl CoA represented by the chemical formula [9] to [15].

3-hydroxyacyl CoA can be synthesized by selected method optionally selected from in vitro synthesis using enzyme, in vivo synthesis using microbes or plants and chemical synthesis. Especially the enzymatic synthesis is a method generally used in the synthesis of said substrate, and following method using commercially available acyl CoA synthetase (acyl CoA ligase, E.C.6.2.1.3): acyl CoA synthetase 3-hydroxyalcanoate+CoA→3-hydroxyacyl CoA is known (Eur. J. Biochem., 250, 432-439 (1997) and Appl. Microiol. Biotechnol., 54, 37-43 (2000). In the synthetic process using enzyme or biological material, batch type synthetic method can be used, or continuous production using immobilized enzyme or immobilized cells can also be used.

<Conversion of Structure of PHA by Oxidative Reaction>

The structure covered by PHA containing unit of the chemical formula [2] having R2 selected from the group consisting of epoxy group and COOR21 (wherein R21 represents any of H, Na and K) can be obtained by the oxidative reaction of the vinyl group in the structure, which is covered by PHA containing unit represented by the chemical formula [2] wherein R2 is vinyl group.

Further, the structure covered by PHA containing any unit selected from the group consisting of the chemical structure [7] and [8] can be obtained by the oxidative reaction of the substituted or unsubstituted phenylthio group in the structure, which is covered by PHA containing unit having the substituted or unsubstituted phenylthio group represented by the chemical formula [16] obtained by polymerization in the system containing 3-hydroxyacyl CoA represented by the chemical formula [15].

<PHA Synthetase and Production Microbes thereof>

As for PHA synthetase used in the present invention, the enzyme produced by microbes preferably selected from said enzyme producing microbes, or the transformant, to which PHA synthetase gene of said microbes is transferred, can be used.

With regard to PHA synthetase producing microbes, for example, mcl-PHA or unusual-PHA producing microbes can be used. Examples of such microbes are above described Pseudomonas oleovorans, Pseudomonas resinovorans, Pseudomonas strain 61-3, Pseudomonas putida KT2442, Pseudomonas aeruginosa, and in addition to the above, strains isolated by the present inventors, i.e. bacterial strain belonging to Pseudomonas sp., such as Pseudomonas putida P91, Pseudomonas cichorii H45, Pseudomonas cichorii YN2 and Pseudomonas jessenii P161, and microbe belonging to Burkholderia sp., such as Burkholderia sp. OK3 FERM P-17370 disclosed in Japanese Patent Application Laid-Open No. 2001-78753 and Burkholderia sp. OK4 FERM P-17371 disclosed in Japanese Patent Application Laid-Open No. 2001-69968. In addition to these microbes, microbes belonging to genus Aeromonas and genus Comamonas and mcl-PHA or unusual-PHA producing microbes can be used.

These strains are deposited on Nov. 20, 2000 to International Patent Organism Depositary, National Institute of Advanced Industrial Science and Technology, in AIST Tsukuba Central 6, 1-1, Higashi 1-chome, Tsukuba-shi, Ibaraki-ken, 305-8566 Japan with the accession Nos.

FERM BP-7373 for Strain P91; FERM BP-7374 for strain H45; FERM BP-7375 for strain YN2; and FERM BP-7376 for strain P161.

Taxonomical properties of the strain P91, strain H45, strain YN2 and strain P161 are as follows. A base sequence of 16S rRNA of the strain P161 is shown in SEQ ID NO:1.

(Taxonomical Properties of Pseudomonas putida P91)

(1) Morphological Properties

Shape and size of cells: rod, 0.6 μm×1.5 μm
Polymorphism of cells: none
Motility: motile
Sporulation: none
Gram staining: negative
Form of colony: round, smooth edge, low convex,
smooth surface, luster and cream color
(2) Physiological Properties
Catalase: positive
Oxidase: positive
O/F test: oxidative
nitrate reduction: negative
indole formation: negative
Glucose acidification: negative
Arginine dihydrolase: positive
Urease: negative
Hydrolysis of esculin: negative
Hydrolysis of gelatin: negative
β-galactosidase: negative
Fluorescent pigment formation in King's B agar: positive
   (3) Substrate Utilization
Glucose: positive
L-arabinose: negative
D-mannose: negative
D-mannitol: negative
N-acetyl-D-glucosamine: negative
Maltose: negative
Potassium gluconate: positive
n-capric acid: positive
Adipic acid: negative
dl-malic acid: positive
Sodium citrate: positive
phenyl acetate: positive
   (Taxonomical Properties of Pseudomonas cichorii H45)
   (1) Morphological Properties
Shape and size of cells: rod, 0.8 μm×1.0-1.2 μm
Polymorphism of cells: none
Motility: motile
Sporulation: none
Gram staining: negative
Form of colony: round, smooth edge, low convex, smooth surface, luster and cream color
   (2) Physiological Properties
Catalase: positive
Oxidase: positive
O/F test: oxidative
nitrate reduction: negative
indole formation: negative
Glucose acidification: negative
Arginine dihydrolase: negative
Urease: negative
Hydrolysis of esculin: negative
Hydrolysis of gelatin: negative
β-galactosidase: negative
Fluorescent pigment formation in King's B agar: positive
Growth in 4% NaCl: negative
Accumulation of poly-β-hydroxy butyric acid: negative
   (3) Substrate Utilization
Glucose: positive
L-arabinose: negative
D-mannose: positive
D-mannitol: positive
N-acetyl-D-glucosamine: positive
Maltose: negative
Potassium gluconate: positive
n-capric acid: positive
Adipic acid: negative
dl-malic acid: positive
Sodium citrate: positive
phenyl acetate: positive
   (Taxonomical Properties of Pseudomonas cichorii YN2)
   (1) Morphological Properties
Shape and size of cells: rod, 0.8 μm×1.5 to 2.0 μm
Polymorphism of cells: none
Motility: motile
Sporulation: none
Gram staining: negative
Form of colony: round, smooth edge, low convex, smooth surface, luster and semitransparent
   (2) Physiological Properties
Catalase: positive
Oxidase: positive
O/F test: oxidative
nitrate reduction: negative
indole formation: positive
Glucose acidification: negative
Arginine dihydrolase: negative
Hydrolysis of gelatin: negative
β-galactosidase: negative
Fluorescent pigment formation in King's B agar: positive
Growth in 4% NaCl: positive (weal growth)
Accumulation of poly-β-hydroxy butyric acid: negative
Hydrolysis of Tween 80: positive
   (3) Substrate Utilization
Glucose: positive
L-arabinose: positive
D-mannose: negative
D-mannitol: negative
N-acetyl-D-glucosamine: negative
Maltose: negative
Potassium gluconate: positive
n-capric acid: positive
Adipic acid: negative
dl-malic acid: positive
Sodium citrate: positive
phenyl acetate: positive
   (Taxonomical Properties of Pseudomonas jessenii P161)
   (1) Morphological Properties
Shape and size of cells: spherical, φ0.6 μm, rod, 0.6 μm×1.2 to 2.0 μm
Polymorphism of cells: + (elongate type)
Motility: motile
Sporulation: none
Gram staining: negative
Form of colony: round, smooth edge, low convex, smooth surface, luster and pale yellow
   (2) Physiological Properties
Catalase: positive
Oxidase: positive
O/F test: oxidative
nitrate reduction: positive
indole formation: negative
Argirine dihydrolase: positive
Urease: negative
Hydrolysis of esculin: negative
Hydrolysis of gelatin: negative
β-galactosidase: negative
Fluorescent pigment formation in King's B agar: positive
   (3) Substrate Utilization
Glucose: positive
L-arabinose: positive
D-mannose: positive
D-mannitol: positive
N-acetyl-D-glucosamine: positive
Maltose: negative
Potassium gluconate: positive
n-capric acid: positive
Adipic acid: negative
dl-malic acid: positive
Sodium citrate: positive
phenyl acetate: positive

For normal culture of microorganisms for use in production of PHA synthesizing enzymes according to the present invention, for example preparation of stock strains, and reproduction for securing the number of cells and their active states required for production of the PHA synthesizing enzyme, a culture medium containing components needed for growth of microorganisms to be used is appropriately selected and used. For example, any type of culture media such as general natural culture media (broths, yeast extracts, etc) and synthetic culture media with nutrient sources added thereto may be used unless they adversely affect growth and survival of microorganisms.

For the culture, any method such as liquid culture and solid culture may be used as long as reproduction of the microorganisms is possible. In addition, any type of culture including batch culture, fed batch culture, semi-continuous culture and continuous culture may be used. As for the form of the liquid batch culture, a method in which oxygen is supplied by shaking with a shaking flask, a method in which oxygen is supplied using a stirring aeration system with a jar fermenter and the like are employed. In addition, a multi-stage method in which these steps are connected in multiple stages may be employed.

In the case where the PHA synthesizing enzyme is produced using PHA producing microorganisms as described above, for example, a method in which the microorganism is grown in an inorganic culture medium containing alkanoic acid such as octanoic acid and nonanoic acid, and cells of the microorganism in the logarithmic growth phase to the early stage of the stationary. phase are collected by centrifugation or the like to extract a desired enzyme, and so on may be used. Furthermore, if the microorganism is cultured using a condition as described above, mcl-PHA derived from added alkanoic acid is synthesized in a cell of the microorganism, but in this case, it is generally said that the PHA synthesizing enzyme exists in such a manner as to be bound to small particles of PHA produced in the cell. However, as a result of studies conducted by the inventors, it has been found that almost equivalent enzyme activity is present even in the supernatant liquid after conducting centrifugation of the liquid from fragmentation of cells cultured by any of the above described methods. It is assumed that this is because an almost equivalent amount of PHA synthesizing enzyme exists in a free state in a relatively early stage of culture, which is from the logarithmic growth phase to the early stage of the stationary phase as described above, since the enzyme is actively produced continuously in the cell.

For the inorganic culture medium for use in the above culture methods, any medium containing components enabling microorganisms to be grown such as phosphorous sources (e.g. phosphates) and nitrogen sources (e.g. ammonium salts, nitrates, etc.) may be used, and inorganic culture media may include, for example, a MSB medium, E medium (J. Biol. Chem., 218, 97-106 (1956)) and M9 medium. Furthermore, the composition of the M9 medium for use in Examples of the present invention is as follows:

Na₂HPO₄: 6.2 g

KH₂PO₄: 3.0 g

NaCl: 0.5 g

NH₄Cl: 1.0 g (per liter of medium, pH 7.0).

In addition, about 0.3% (v/v) of a solution containing minor components shown below is preferably added in the above inorganic culture medium for ensuring satisfactory growth of the microorganism and production of the PHA synthesizing enzyme:

(Solution Containing Minor Components)

nitrilotriacetic acid: 1.5 g

MgSO₄: 3.0 g

MnSO₄: 0.5 g

NaCl: 1.0 g

FeSO₄: 0.1 g

CaCl₂: 0.1 g

CoCl₂: 0.1 g

ZnSO₄: 0.1 g

CuSO₄: 0.1 g

AlK (SO₄)₂: 0.1 g

H₃BO₃: 0.1 g

Na₂MoO₄: 0.1 g

NiCl₂: 0.1 g

(per liter)

The culture temperature may be any temperature at which the above microorganism can satisfactorily be grown, for example 14 to 40° C., preferably 20 to 35° C.

Also, a desired PHA synthesizing enzyme can be produced using a transformant having a PHA synthesizing enzyme gene of the aforesaid PHA producing microorganism. Cloning of the PHA synthesizing enzyme gene, preparation of an expression vector, and preparation of the transformant may be carried out in accordance with an established method. In a transformant obtained with a microorganism such as colibacillus as a host, the medium for use in culture is a natural medium or a synthetic medium, for example, a LB medium, M9 medium or the like. A culture temperature is in the range of from 25 to 37° C. In addition, aerobic culture is conducted for 8 to 27 hours to achieve growth of the microorganism. Thereafter, cells can be collected to collect the PHA synthesizing enzyme accumulated in the cells. Antibiotics such as kanamycin, ampicillin, tetracycline, chloramphenicol and streptomycin may be added in the medium as necessary. Also, in the case where an inductive promoter is used in the expression vector, an inductive material corresponding to the promoter may be added to the medium to promote expression when the transformant is cultured. Such inductive materials include, for example, isopropyl-1-thio-β-D-galactoside (IPTG), tetracycline and indolacrylic acid (IAA).

For the PHA synthesizing enzyme, liquids from fragmentation of cells of microorganism, and crude enzymes such as salted ammonium sulfate obtained by precipitation and collection of protein components with ammonium sulfate and the like may be used, or enzymes purified by various kinds of methods may be used. Stabilizers such as metal salts, glycerin, dithiothreitol, EDTA and bovine serum albumin (BSA), and activators may be added to the enzymes as necessary.

For isolation and purification of PHA synthesizing enzymes, any method allowing enzyme activation of PHA synthesizing enzymes to be retained may be used. For example, obtained cells of microorganism are crushed with a French press, a supersonic crusher, lysozyme, various kinds of surfactants and the like, and thereafter, for a crude enzyme solution obtained by centrifugation or salted ammonium sulfate prepared therefrom, means such as affinity chromatography, cation or anion exchange chromatography, and gel filtration is applied alone or in combination, whereby a purified enzyme can be obtained. In particular, a gene recombination protein can be purified more conveniently by expressing the protein in the form of united protein with “tags” such as histidine residues bound to the N terminal and C terminal, and making the protein to be bound to an affinity resin through these tags. For isolating a desired protein from the united protein, methods of cleaving the linkage by protease such as thrombin and a blood coagulation factor Xa, decrasing the pH, adding a high concentration of imidazole as a competitive binding agent and the like may be used. Alternatively, if the tag includes intein as in the case of using pTYB1 (manufactured by New EnglanBiolab Co., Ltd.) as a expression vector, a reduction condition is achieved by dithiothreitol or the like to cleave the linkage. For the united protein enabling purification by affinity chromatography, glutathione-S-transferase (GST), chitin bound domain (CBD), maltose bound protein (MBP) and thioredoxine (TRX) are also well known in addition to the histidine tag. The GST united protein can be purified by the GST affinity resin.

A various kinds of reported methods may be used for measuring activity of the PHA synthesizing enzyme, and for example, the activity may be measured by the following method in which as a measurement principle, CoA released in the process through which 3-hydroxyacyl CoA is polymerized under the catalytic action of the PHA synthesizing enzyme to form PHA is colored with 5,5′-dithiobis-(2-nitrobenzoic acid) to carry out measurements. Reagent 1: bovine serum albumin (manufactured by Sigma Co., Ltd.) is dissolved in a 0.1 M Tris hydrochloric buffer (pH 8.0) in the concentration of 3.0 mg/ml, Reagent 2: 3-hydroxyoctanoyl CoA is dissolved in a 0.1 M Tris hydrochloric buffer (pH 8.0) in the concentration of 3.0 mM, Reagent 3: trichloroacetic acid is dissolved in a 0.1 M Tris hydrochloric buffer (pH 8.0) in the concentration of 10 mg/ml, and Reagent 4: 5,5′-dithiobis-(2-nitrobenzoic acid) is dissolved in a 0.1 M Tris hydrochloric buffer (pH 8.0) in the concentration of 2.0 mM. First reaction (PHA synthesis reaction): 100 μl of Reagent 1 is added in 100 μl of sample (enzyme) solution and mixed together, and is pre-incubated at 30° C. for a minute. 100 μl of Reagent 2 is added thereto and mixed together, and is incubated at 30° C. for 1 to 30 minutes, followed by adding thereto Reagent 3 to stop the reaction. Second reaction (reaction of coloring free CoA): the first reaction solution of which reaction has been stopped is subjected to centrifugation (15,000×g, 10 minutes), and 500 μl of Reagent 4 is added in 500 μl of supernatant liquid of this solution, and is incubated at 30° C. for 10 minutes, followed by measuring an absorbance at 412 nm. Calculation of enzyme activity: the amount of enzyme for releasing 1 μmol of CoA per minute is defined as one unit (U).

The PHA synthesized by said enzyme is generally isotactic polymer constituted by R-configuration.

<Base Material>

A base material used for the method of the present invention can be selected from common polymer compound or inorganic solid material such as resin, glass, metal, etc. if it can immobilize PHA synthetase. Types and structure of the base material can be selected depending on immobilizing method of PHA synthetase and applicable form of prepared structure.

Examples of the base material (core) of the capsule contract of the present invention include resin particulates produced by polymerizing polymerizable monomers selected from the group consisting of styrene base polymerizable monomers such as styrene, α-methylstyrene, β-methylstyrene, o-methylstyrene, m-methylstyrene, p-methylstyrene, 2,4-dimethylstyrene, p-n-butylstyrene, p-tert-butylstyrene, p-n-hexylstyrene, p-n-octylstyrene, p-n-nonylstyrene, p-n-decylstyrene, p-n-dodecylstyrene, p-methoxystyrene, and p-phenylstyrene, acrylic polymerizable monomers such as methyl acrylate, ethyl acrylate, n-propyl acrylate, iso-propyl acrylate, n-butyl acrylate, iso-butyl acrylate, tert-butyl acrylate, n-amyl acrylate, n-hexyl acrylate, 2-ethylhexyl acrylate, n-octyl acrylate, n-nonyl acrylate, cyclohexyl acrylate, benzyl acrylate, dimethylphophate ethyl acrylate, diethylphosphate ethyl acrylate, dibutylphosphate ethyl acrylate, and 2-benzoyloxyethyl acrylate, methacrylic polymerizable monomers such as methyl methacrylate, ethyl methacrylate, n-propyl methacrylate, iso-propyl methacrylate, n-butyl methacrylate, iso-butyl methacrylate, tert-butyl methacrylate, n-amyl methacrylate, n-hexyl methacrylate, 2-ethylhexyl methacrylate, n-octyl methacrylate, n-nonyl methacrylate, diethylphosphate ethyl methacrylate, and dibutylphosphate ethyl methacrylate, vinyl base polymerizable monomers including methylene aliphatic monocarboxylates, vinyl ethers such as vinyl acetate, vinyl propionate, vinyl benzoete, vinyl butylate, vinyl benzoate, and vinyl formate, vinyl ethers such as vinylmethyl ether, vinylethyl ether, and vinylisobutyl ether, vinyl ketones such as vinyl methyl ketone, vinyl hexyl ketone, and vinyl isopropyl ketone; resin particulates produced by adding to the above described monomers a variety of additives such as polymers of polar groups and colorants; particulates including paraffin wax, polyolefin wax, Fischer Tropshch wax, amide wax, higher fatty acids, ester wax, derivatives thereof, graft compounds thereof, and block compounds thereof; clay minerals such as kaolinite, bentonite, talc, and mica; metal oxides such as alumina and titanium dioxide; insoluble inorganic salts such as silica gel, hydroxyapatite, and calcium phosphate gel; black pigments such as carbon black, copper oxide, manganese dioxide, aniline black, activated carbon, nonmagnetic ferrite, and magnetite; yellow pigments such as Chrome Yellow, Zinc Yellow, Iron Oxide Yellow, Cadmium Yellow, Mineral Fast Yellow, Nickel Titanium Yellow, Neburs Yellow, Naphthol Yellow S, Hanzar Yellow G, Hanza Yellow 10G, Benzidine Yellow G, Benzidine Yellow GR, Quinoline Yellow Lake, Permanent Yellow NCG, and Turtladine Lake; orange pigments such as Orange Chrome, Molybdenum Orange, Permanent Orange GTR, Pyrazolone Orange, Vulcan Orange, Benjidine Orange G, Indanthlene Brilliant Orange RK, and Indanthlene Brilliant Orange GK; red pigments such as Red Iron Oxide, Cadmium Red Lead, mercury sulfate, cadmium, Permanent Red 4R, Lithol Red, Pyrazolone Red, Watching Red, calcium salt, Lake Red C, Lake Red D, Brilliant Carmin 6B, Brilliant Carmin 3B, Eoxine Lake, Rhodamine Lake B, or Alizarin Lake; blue pigments such as Milori Blue, Cobalt Blue, Alkali Blue Lake, Victoria Blue Lake, Phthalocyanine Blue, Non-metal Phthalocyanine Blue, partly chloride Phthalocyanine Blue, Fast Sky Blue, and Indanthrene Blue BC; violet pigments such as Manganese Violet, Fast Violet B. or Methyl Violet Lake; green pigments such as chromium oxide, Chrome Green, Pigment Green B, Malachite Green Lake, and Final Yellow Green G; white pigments such as Zinc White, titanium oxide, Antimony White, zinc sulfate; and extender pigments such as baryta powder, barium carbonate, clay, silica, white carbon, talc, and Alumina White. Of course, the granular base material is not limited to these substances. Form of core can preferably be selected depending on it usage and is, for example, preferably particles having particle size within the range of the particle size from 1.0 nm to 1.0 mm. Further, in case that said structure is used as capsule toner for electrophotograph, the particle size is preferably selected from the range between 3.0 μm and 10 μm.

In addition, other forms of the base material of the laminated structure of the present invention include films made of plastics such as poly(ethylene terephthalate) (PET), diacetates, triacetates, cellophane, celluloid, polycarbonates, polyimides, polyvinyl chloride, poly(vinylidene chloride), polyacrylate, polyethylene, polypropylene, and polyesters; porous polymer membranes such as poly(vinyl chloride), poly(vinyl alcohol), acetyl cellulose, polycarbonate, nylon, polypropylene, polyethylene, and Teflon®; clothes such as wooden plates, glass plates, cotton, rayon, acryl, silk, and polyesters; and paper such as high quality paper, medium quality paper, art paper, bond paper, recycled paper, baryta paper, cast coat paper, corrugated cardboard paper, and resin coat paper. Off course, the base material is not limited to these materials. Further, the aforementioned base material is acceptable even if its surface is even or uneven, or even if it is transparent, translucent, or opaque. Furthermore, a material made by binding two or more materials of the aforementioned base materials to one another is acceptable.

<Preparation of Structure>

The method for production of the structure of the present invention includes a process for immobilizing PHA synthetase in the base material and a process for synthesizing PHA by reacting with said immobilized PHA synthetase and 3-hydroxyacyl CoA.

With regard to a method for immobilizing PHA synthetase in the base material, the method optionally selected from conventionally used immobilizing methods of enzyme can be used, if activity of the enzyme can be maintained and the method can be applied for the desired base material. For example, covalent bonding method, ion adsorption method, hydrophobic adsorption method, physical adsorption method, affinity adsorption method, crosslinking method and lattice inclusion method can be exemplified, and the immobilizing method applying ion adsorption and hydrophobic adsorption is preferable.

Enzyme protein such as PHA synthetase is a polypeptide, which is bound with large numbers of amino acids, and indicates properties as the ion adsorbate exhibited by amino acids having free ionic group such as lysine, histidine, arginine, aspartic acid and glutamic acid, and further it has properties of hydrophobic adsorbate exhibited by amino acids having free hydrophobic group such as alanine, valine, leucine, isoleucine, methionine, tryptophan, phenylalanine and proline, or properties of organic polymer. Consequently, although adsorbability varies, the enzyme can be adsorbed on the solid surface having ionic property or hydrophobic property, or both properties.

In a method for immobilizing PHA synthetase mainly by ion adsorption, a core, which expresses ionic functional group on the surface, is preferably used, and for example, clay mineral such as kaolinite, bentonite, talc and mica, metal oxide such as alumina and titanium dioxide, and insoluble inorganic salt such as silica gel, hydroxyl apatite and calcium phosphate gel can be used as the core. Inorganic pigment having main component of these substances, ion exchange resin, chitosan, and polymer having ionic functional group such as polyamino polystyrene can be used as ion adsorptive core.

In a method for immobilizing PHA synthetase mainly by hydrophobic adsorption, the core having non-polar surface can preferably be used. Many polymers, in which ionic functional group is not expressed on the surface or hydrophobic functional group is expressed on the surface, such as styrene based polymer, acrylate based polymer, methacrylate based polymer, vinyl esters, vinyl based polymer, etc. can be used as the core. Organic dye such as azo dye having plural aromatic rings, fused polycyclic phthalocyanine dye and anthraquinone dye and carbon black is hydrophobic adsorptive.

Immobilization of PHA synthetase to the core by ion adsorption or hydrophobic adsorption can be achieved by mixing the enzyme and the core in a predetermined reaction liquid. In this time, in order to uniformly adsorb the enzyme to the surface of the core, the reaction vessel is preferably shaken. or stirred by proper force.

Since positive or negative of the surface charge and charge numbers and hydrophobicity of the core and PHA synthetase are changed depending on pH, salt concentration or temperature of the reaction liquid, the solution is preferably adjusted depending upon characteristics of the core used within acceptable ranges of the enzymatic activity. For example, when the core is mainly ion adsorptive, charge numbers involving in the adsorption of the core and PHA synthetase can be increased by decreasing the salt concentration. Further, counter charge of both can be increased by changing pH. When the core is mainly hydrophobic adsorptive, hydrophobicity of both can be increased by increasing salt concentration. Further, the condition of solution suitable for adsorption can be set by measuring the electrophoretic migration and the wetting angle previously and examining charge condition of the core and PHA synthetase. The condition can be obtained by directly measuring the amount of adsorption of the core and PHA synthetase. Measurement of amount of adsorption can be performed: for example, after the PHA synthetase solution of a known concentration is added to the solution suspending the core to perform adsorption treatment, a concentration of PHA synthetase in the solution is measured, and the amount of adsorbed enzyme is obtained by the subtraction method.

In case of core material difficult to immobilize enzyme by ion adsorption and hydrophobic adsorption, immobilization may be performed by covalent bonding method, if troublesome operation and denature of enzyme are considered. Examples include: a method wherein solid particles having aromatic amino group are diazotized and the enzyme is subjected to diazo coupling; a method forming peptide bond between the solid particle having carboxyl group or amino group and the enzyme; a method for alkylation between the solid particles having halogen group and amino group of the solid particles; a method for reacting polysaccharide particles activated by cyanogen bromide and amino group in the enzyme; a method for crosslinking between amino group in the solid particles and amino group in the enzyme; a method for reacting solid particles having carboxyl group and amino group and the enzyme in the presence of a compound having aldehyde group or ketone group and isocyanide compound; and a method for an exchange reaction between solid particles having disulfide group and a thiol group of the enzyme.

The enzyme can be adsorbed to solid particles by affinity adsorption. Affinity adsorption means a biological adsorption between the biopolymer and the specific substance called ligand which shows specific affinity to the biopolymer, and for example it includes: enzyme and substrate; antibody and antigen; receptor and neurotransmitter such as acetylcholine; and MRNA and tRNA. Generally, a method for immobilizing enzyme by applying affinity adsorption includes a method wherein a ligand such as substrate of enzyme or its reaction product, competitive inhibitor, coenzyme, allosteric effecter is bound with the solid, and the enzyme is added to the solid to perform affinity adsorption. However, in the PHA synthetase, for example, when a substrate, 3-hydroxyacyl CoA is used as a ligand, an active site, which catalyzes PHA synthesis in the enzyme, is blocked by binding with the ligand, and as a result, a problem wherein PHA can not be synthesized will occur. However, PHA synthetic activity of the PHA synthetase can be maintained after performing immobilization by fusing the other biopolymer to the PHA synthetase and using the ligand of the biopolymer for affinity adsorption. Fusion of PHA synthetase and biopolymer can preferably be made by genetic engineering means or by chemical bonding means with PHA synthetase. The biopolymer used is any of product for which the corresponding ligand is easily available, and such ligand is easy to bind with the core. In case that the fused product is expressed by gene recombination means, protein is preferable. Concretely, using E. coli, in which gene sequence expressing GST is ligated with gene sequence of PHA synthetase by the transformation, a fused protein with GST and PHA synthetase is produced, and Sepharose binding with glutathione, a ligand for GST, is added to the protein, thereby PHA synthetase can be affinity adsorbed with Sepharose.

A peptide containing amino acid sequence having ability to bind with the base material is fused with PHA synthetase and is presented, and based on binding with the peptide region of the amino acid sequence having binding ability to said base material and the base material, PHA synthetase can be immobilized on the surface of said base material.

Amino acid sequence having binding ability to the base material can be determined, for example, by screening of the random peptide library. The phage display peptide library, which is prepared, for example, by ligating a random synthetic gene to a gene in the N-terminal of the surface protein of M13 phage (e.g. gene III protein), can preferably be used, and in this case, the amino acid sequence having binding ability to the base material is determined by the following procedure. Namely, the phage display peptide library is contacted with the base material or at least one component constituting said base material by adding the said library, and then the binding phage and non-binding phage were separated by washing. After eluting the base material bound phage by acid, etc. and neutralizing with buffer, the phage was infected to E. coli and proliferated. Plurality of clones having binding ability to the objective base material can be concentrated by repeated operation of the selection. In order to obtain single clone, reinfected E. coli is spread on the medium plate to form colonies. After culturing each single colony in the liquid medium, phage in the culture supernatant is precipitated by using polyethylene glycol and purified, the base sequence is analyzed to find out the peptide structure.

The amino acid sequence of the peptide obtained by the above method having binding ability to the base material can be utilized with fusing PHA synthetase by means of conventional genetic engineering technique. The peptide having binding ability to the base material can be expressed by ligating to N-terminal or C-terminal of PHA synthetase. Expression can also be performed by inserting proper spacer sequence. Preferable spacer sequence is about 3 to 400 amino acids and can be included any amino acids. Most preferable spacer sequence is the sequence which does not inhibit function of PHA synthetase and not inhibit binding to the base material.

The immobilized enzyme prepared by the above method can be used as it is but can also be used by treatment with freeze drying.

When one unit (U) of PHA synthetase is defined by the liberated amount of CoA 1 μmol/min in the synthetic reaction of PHA by polymerization of 3-hydroxyacyl CoA, amount of enzyme immobilized in the base material, for example in case that the base material is the core of the capsule structure, is preferably 10 units. (U) to 1,000 units (U), more preferably 50 units (U) to 500 units (U).

A substrate, a PHA synthase on the base material surface synthesizes a PHA by the introduction of the aforementioned immobilized enzyme into an aqueous reaction solution containing a 3-hydroxyacyl CoA to become a raw material of a desirable PHA to thereby form a structure, the base material of which is coated with the PHA. The aforementioned aqueous reaction solution should be prepared as a reaction system wherein the activity of the PHA synthase is to be fully performed, and is adjusted from pH 5.5 to pH 9.0 by a buffer solution, preferably from pH 7.0 to pH 8.5. However, other conditions besides the above ranges may be set up, depending on the pH suitability and stability of a PHA synthase to be used. The kind of the buffer solution can be selected, as required, depending on the pH range to be set up, if the activity of the PHA synthase is to be fully performed. Usable buffers for general biochemical reactions include, for example, an acetic acid buffer, phosphoric acid buffer, potassium phosphate buffer, 3-(N-morphorino)propane sulfonic acid (MOPS) buffer, N-tris(hydroxymethyl)methyl-3-aminopropane sulfonic acid (TAPS) buffer, tris-hydrochloric acid buffer, glycine buffer, and 2-(cyclohexylamino)ethane sulfonic acid (CHES) buffer. The concentration of the buffer solution to be used is also not limited if the activity of the PHA synthase to be used is to be fully performed, and is normally from 5.0 mmol/L to 1.0 mol/L, preferably from 0.1 mol/L to 0.2 mol/L. The reaction temperature is set up, as required, depending on the characteristics of a PHA synthase to be used, and is normally from 4° C. to 50° C., preferably from 20° C. to 40° C. However, other conditions besides the above ranges may be set up, depending on the temperature suitability and thermal resistance of a PHA synthase to be used. The reaction time varies with the stability or the like of a PHA synthase to be used, and is normally from 1 minute to 24 hours, preferably is selected, as required, within the range of 30 minutes to 3 hours. The concentration of a 3-hydroxyacyl CoA in the reaction solution is set up, as required, within the range wherein the activity of a PHA synthase to be used is to be fully performed, and is normally from 0.1 mmol/L to 1.0 mol/L, preferably is set up within the range of 0.2 mmol/L to 0.2 mol/L. Additionally, when the concentration of a 3-hydroxyacyl CoA in the reaction solution is high, the pH of the reaction system generally tends to decrease, and so the aforementioned buffer is preferably set up at a slightly higher concentration as well when a 3-hydroxyacyl CoA is set up at a high concentration.

In the above process, a monomer unit composition of PHA coating the base material can be changed to the direction from the inner side to the outer side in case of the structure having particle form and to the vertical direction in case of the structure having flat form by changing the composition such as type and concentration of 3-hydroxyacyl CoA in the aqueous reaction liquid.

In the form of the structure, in which monomer unit composition is changed, the form wherein the base material is coated by a single layer of PHA having continuously varied composition of the PHA coat in a gradient of the composition in the direction from the inner side to the outer side or to the vertical direction can be mentioned. It can be produced by, for example, adding 3-hydroxyacyl CoA having different composition into the reaction liquid during synthesis of PHA.

In another form, the form wherein the base material is covered by multiple layers of PHA coatings having stepwisely changing composition as well as having different composition, can be mentioned. It can be produced by the process as follows. After synthesizing PHA in the proper composition of 3-hydroxyacyl CoA, the structure under preparation is recovered once from the reaction liquid by centrifugation, and the reaction liquid consisting of different composition of 3-hydroxyacyl CoA is further added.

Proper amount of compound having hydroxyl group is preferably added to the reaction liquid from the standpoint of the regulation of molecular weight of PHA and improved hydrophilicity of the PHA coating.

Examples of compounds having hydroxyl group used in the present invention are at least one of compounds selected from the group consisting of alcohol, diol, triol, alkylene glycol, polyethylene glycol, polyethylene oxide, alkylene glycol monoester, polyethylene glycol monoester and polyethylene oxide monoester. More particularly, the following examples can be mentioned. Alcohol, diol and triol are C₃₋₁₄ straight or branched alcohol, diol and triol. Alkylene glycol and alkylene glycol monoester having C₂₋₁₀ straight or branched carbon chain can be mentioned. Number average molecular weight of polyethylene glycol, polyethylene oxide, polyethylene glycol monoester and polyethylene oxide monoester is within the range from 100 to 20,000.

Concentration of the compound having hydroxyl group is not limited, if the polymerization reaction of 3-hydroxyacyl CoA with PHA synthetase is not inhibited. Preferably 0.01% to 10% (w/v) to the reaction liquid of PHA synthetase and 3-hydroxyacyl CoA, more preferably 0.02% to 5% (w/v), is added in the initial stage of the reaction at once or added stepwisely to the reaction liquid during the reaction process by dividing several times.

The structure obtained by the above described reaction is, as required, given to the washing step. The method of washing is not particularly limited, as long as it does not bring about an undesirable change in the structure against the purpose of production of the structure. When a structure is a capsule structure with its base material being the core and the PHA being the out shell, the unnecessary components contained in the reaction solution can be removed, for example, by precipitating the structure by means of centrifuge separation and removing the supernatant. In this case, further cleaning can also be performed by adding a cleaning agent in which the PHA is not dissolved, such as water, a buffer solution, or methanol, and then running centrifuge separation. In addition, a method such as filtration or the like may be utilized instead of centrifuge separation. On the other hand, a structure is a structure, the plate-like base material of which is coated with a PHA, cleaning can be conducted, for example, by immersing it in an aforementioned cleaning agent. Also, the aforementioned structure can be, as required, given to the drying step. Furthermore, the structure can be treated by various secondary processing, chemical modification, etc. prior to utilization.

For example, the structure having more useful function and characteristics can be obtained by adding.chemical modification to PHA covering the structure.

<Synthesis of PHA by Oxidative Reaction in the Present Invention -Carboxyl Group->

The unit having carboxyl group in the unit represented by the chemical formula (2) can be produced by selective oxidative cleavage of a double bond of the unit having biphenyl group in the side chain terminal, and PHA containing the unit having carboxyphenyl group shown in the chemical formula (2) can be obtained.

Examples of methods for obtaining carboxylic acid by oxidative cleavage of C—C double bond using oxidizing agent are, for example, a method using permanganate, (J. Chem. Soc., Perkin. Trans. 1, 806 (1973)), a method using bichromate (Org. Synth., 4, 698 (1963)), a method using periodate (J. Org. Chem., 46, 19 (1981)), a method using nitric acid (Japanese Patent Application Laid-Open No. S59-190945), and a method using ozone (J. Am. Chem. Soc., 81, 4273 (1959)). With regard to PHA, C—C double bond of the side chain terminal of PHA is cleaved by potassium permanganate as oxidizing agent under acidic condition to obtain the carboxylic acid. These methods can be applied to the present invention.

The permanganate used as oxidizing agent is generally potassium permanganate. Amount of permanganate used is, since the oxidative cleavage reaction is the stoichiometric reaction, generally 1 molar equivalent or more for one mole of unit represented by the chemical formula (2) having vinyl group, preferably 2 to 4 molar equivalents.

Various inorganic acid and organic acid such as sulfuric acid, hydrochloric acid, acetic acid and nitric acid can be used for performing the reaction under acidic condition. However, when acid such as sulfuric acid, hydrochloric acid and nitric acid is used, there is a possibility to cleave ester bond of the main chain of PHA to result molecular weight decrease. For that reason, acetic acid is preferably used. Amount of acid used is generally 0.2 to 200 molar equivalents for one mole of unit represented by the chemical formula (2) having vinyl group, preferably 0.4 to 100 molar equivalents. If the amount is 0.2 molar equivalent or less, low yield has to occur, and if it is 200 molar equivalent or more, degradation product caused by acid is produced, consequently these cases are not preferable. In order to promote the reaction, crown ether can be used. The crown ether and permanganate form complex to increase reaction activity. Dibenzo-18-crown-6-ether, dicyclo-18-crown-6-ether and 18-crown-6-ether are generally used as crown ether. Amount of crown ether used is generally 1.0 to 2.0 molar equivalents for one mole of permanganate, preferably 1.0 to 1.5 molar equivalent.

In the oxidative reaction of the present invention, the structure coated with PHA containing the unit represented by the chemical formula (2) having vinyl group, permanganate and acid can be reacted in together from the initial stage, or the reaction can be performed by adding separately with continuously or stepwisely into the reaction system. Reaction may also be performed by dissolving or suspending permanganate in advance, subsequently by adding the structure and acid continuously or stepwisely into the reaction system, or by suspending only the structure previously, subsequently by adding permanganate and acid continuously or stepwisely into the reaction system. Further, the reaction may be performed by adding the structure and acid in advance, subsequently by adding permanganate continuously or stepwisely into the reaction system. The reaction may also be performed by adding permanganate and acid in advance, subsequently by adding the structure continuously or stepwisely into the reaction system. The reaction may further be performed by adding the structure and permanganate in advance, subsequently by adding acid continuously or stepwisely into the reaction system.

Reaction temperature is generally at −20 to 40° C., preferably at 0 to 30° C. Reaction time depends on stoichiometric ratio of the unit represented by the chemical formula (2) having vinyl group and permanganate and reaction temperature, and is generally 2 to 48 hours.

In the same manner, with regard to ω-alkene structure of the chemical formula (1), a conversion from vinyl group to carboxyl group can be made.

<Synthesis of PHA by Oxidative Reaction in the Present Invention -Phenylsulfinyl/Sulfonyl Group->

Polyhydroxyalkanoate containing at least one unit of 3-hydroxy-(phenylsulfinyl)alkanoate unit represented by the chemical formula (7) or 3-hydroxy-(phenylsulfonyl)alkanoate unit represented by the chemical formula (8) can be produced by selectively oxidizing sulfur moiety, i.e. sulfanyl group (—S—), of the unit having substituted or unsubstituted phenylthio group or sulfanyl group (—S—) in the form of substituted or unsubstituted phenylthio group in the side chain terminal represented by the chemical formula (16), as a result, PHA containing at least one of the unit represented by the chemical formula (7) or the unit represented by the chemical formula (8) can be obtained.

In such the oxidative reaction, for example, peroxide can be utilized, and any type of peroxide can be used, if it can contribute to the object of the present invention, namely, oxidation of substituted or unsubstituted phenylthio group or sulfanyl group (—S—) in the form of substituted or unsubstituted phenylthio group. In that occasion, when an efficiency of the oxidation, effect for the main chain skeletal of PHA (and copolymer containing it) and simplicity in the treatment are considered, peroxide selected from the group consisting of hydrogen peroxide, sodium percarbonate, m-chloroperbenzoic acid, performic acid and peracetic acid can preferably be used.

Easier treatment using hydrogen peroxide is explained. Most simple and easy treatment method using hydrogen peroxide is that the structure coated by PHA containing the unit represented by the chemical formula (16), a precursor of PHA of the present invention, is directly suspended in aqueous hydrogen peroxide, and if necessary, heated and stirred for a given time.

In the process for production of the structure of the present invention, hydrogen peroxide utilized as the oxidizing agent can be used in any forms, if the object of the present invention, namely, oxidation of substituted or unsubstituted phenylthio group or sulfanyl group (—S—) in the form of substituted or unsubstituted phenylthio group can be performed. From the standpoint of controlling the production process, hydrogen peroxide solution with stable concentration such as solution in aqueous solvent, i.e. aqueous hydrogen peroxide, is preferably used. For example, product of the industrial mass production, hydrogen peroxide, JIS K-8230, is recommended. Preferable hydrogen peroxide in the process of the present invention is, for example, aqueous hydrogen peroxide, Mitsubishi Gas Chemical Inc., (hydrogen peroxide 31%).

In the process for production of the structure of the present invention, a condition for oxidation using this hydrogen peroxide will be changed depending on the form of the structure to be treated, particle size (specific surface area) in case of particles, molecular structure of coating PHA, etc. In case of using the above hydrogen peroxide, JIS K-8230, (hydrogen peroxide 31%), a condition for dilution (concentration), amount of use, treatment temperature, time, etc. can be selected in the range hereinbelow.

A concentration of hydrogen peroxide in the treatment depends on the reaction temperature, and is 8% (about 4-fold dilution) to 31% (original undiluted solution), preferably 16% (about 2-fold dilution) to 31% (original solution) in the reaction. It depends on a ratio of the unit of the chemical formula (16) in the precursor PHA, and is: for PHA 1 g, 1 ml to 1000 ml, converted value for the original undiluted aqueous hydrogen peroxide (hydrogen peroxide 31%), more preferably the reaction volume is within a range of 5 ml to 500 ml.

Reaction temperature depends on the concentration of the reaction liquid, and is 30° C. to 100° C., preferably 50° C. to 100° C. Reaction time depends on the reaction temperature, and is 10 min. to 180 min., preferably 30 min. to 120 min.

When treatment with hydrogen peroxide is performed within the above condition, the precursor PHA containing the unit represented by the chemical formula (16) can be converted to PHA containing at least one of the units represented by the chemical formula (7) and (8), or PHA, in which the unit represented by the chemical formula (16) derived from the intermediate raw material PHA is still remained, in addition to the units represented by the chemical formula (7) and (8). In the reaction, by selecting the reaction condition of the hydrogen peroxide treatment and by controlling a rate of oxidation reaction process and an amount of reaction, ratio of the above 3 units can be controlled.

A method using peroxide, m-chloroperbenzoic acid (MCPBA) is explained hereinbelow.

When MCPBA is used, oxidation of substituted or unsubstituted phenylthio group or sulfanyl group (—S—) in the form of substituted or unsubstituted phenylthio group proceeds stoichiometrically, and a ratio of content of the unit represented by the chemical formula (7) and (8) is easily controlled. Further since the reaction condition is mild, unnecessary side reaction such as cleavage of PHA main skeletal or crosslinking reaction of an active site is difficult to generate. Consequently, in the process for production of PHA of the present invention for production of the objective product of PHA with high selectivity, m-chloroperbenzoic acid (MCPBA) is one of the highly preferable peroxides.

In example using another compound as peroxide, a method using permanganate is explained. Example of the above permanganate used for oxidizing agent is generally potassium permanganate. Amount of use in permanganate is generally 1 molar equivalent or more, preferably 2 to 4 molar equivalents for 1 mol. of the unit containing substituted or unsubstituted phenylthio group represented by the chemical formula (16).

Various inorganic acid and organic acid such as sulfuric acid, hydrochloric acid, acetic acid and nitric acid can be used for performing the reaction under acidic condition. However, when acid such as sulfuric acid, hydrochloric acid and nitric acid is used, there is a possibility to cleave ester bond of the main chain of polyhydroxyalkanoate to result molecular weight decrease. For that reason, acetic acid is preferably used. Amount of acid used is generally 0.2 to 200 molar equivalents, preferably 0.4 to 100 molar equivalents for one mole of unit containing substituted or unsubstituted phenylthio group represented by,the chemical formula (16). If the amount is 0.2 molar equivalent or less, low yield has to occur, and if it is 200 molar equivalents or more, degradation product caused by acid is produced, consequently these cases are not preferable. In order to promote the reaction, crown ether can be used. The crown ether and permanganate form complex to increase reaction activity. Examples of crown ether generally used are dibenzo-18-crown-6-ether, dicyclo-18-crown-6-ether and 18-crown-6-ether. Amount of crown ether used is generally 1.0 to 2.0 molar equivalents for one mole of permanganate, preferably 1.0 to 1.5-molar equivalent.

In the oxidative reaction of the present invention, the structure coated with PHA containing the unit represented by the chemical formula (16), permanganate and acid can be reacted in together from the initial stage, or the reaction can be performed by adding separately with continuously or stepwisely into the reaction system. Reaction may also be performed by dissolving or suspending only permanganate in advance, subsequently by adding the structure and acid continuously or stepwisely into the reaction system, or by suspending only the structure previously, subsequently by adding permanganate and acid continuously or stepwisely into the reaction system. Further, the reaction may be performed by adding the structure and acid in advance, subsequently by adding permanganate continuously or stepwisely into the reaction system. The reaction may also be performed by adding permanganate and acid in advance, subsequently by adding the structure continuously or stepwisely into the reaction system. The reaction may further be performed by adding the structure and permanganate in advance, subsequently by adding acid continuously or stepwisely into the reaction system.

Reaction temperature is generally at −20 to 40° C., preferably at 0 to 30° C. Reaction time depends on stoichiometric ratio of the unit represented by the chemical formula (16) and permanganate and reaction temperature, and is generally 2 to 48 hours.

According to the oxidation treatment of substituted or unsubstituted phenylthio group represented by the chemical formula (16), the precursor PHA containing the unit represented by the chemical formula (16) can be converted to PHA containing at least one of units represented by the chemical formulae (7) and (8).

Sulfinyl structure (—SO—) or sulfonyl structure (—SO₂—) strongly stimulate localization of electrons in the molecule in such the unit terminal, and the physicochemical properties may be significantly different from the conventional PHA. Especially, glass transition temperature rises significantly and application to wide range of utilities is possible.

<Synthesis of PHA by Oxidative Reaction in the Present Invention -Epoxy Group->

The unit having epoxy group in the unit represented by the chemical formula (2) can be produced by selective oxidative cleavage of a double bond of the unit having biphenyl group in the side chain terminal represented by the chemical formula (2), and PHA containing the unit having epoxyphenyl group shown in the chemical formula (2) can be obtained.

In such the oxidative reaction, for example, peroxide can be utilized, and any type of peroxide can be used, if it can contribute to the object of the present invention, namely, oxidation of vinyl group. In that occasion, when an efficiency of the oxidation, effect for the main chain skeletal of PHA (and copolymer containing it) and simplicity in the treatment are considered, peroxide selected from the group consisting of hydrogen peroxide, sodium percarbonate, m-chloroperbenzoic acid, performic acid and peracetic acid can preferably be used.

The reaction condition of the above described sulfanyl group can be applied for the reaction condition using peroxide.

<Modification of the Structure>

The structure, in which at least a part of the base material is coated with PHA having various properties provided by the graft chain, can be obtained by introducing the graft chain into the PHA. Mechanical strength, chemical resistance and heat resistance of the structure can be controlled by crosslinking the PHA.

Method of chemical modification is not specifically limited, if the method can fulfill the objective for obtaining desired function and structure, and for example, a method wherein PHA having reactive functional group in the side chain is synthesized and the chemical modification is performed by utilizing the chemical reaction of said functional group, can be used as preferable method.

Type of the reactive functional group is not specifically limited, if it can fulfill the objective for obtaining desired function and structure, and for example, the above described epoxy group can be exemplified. PHA having epoxy group as a side chain can perform chemical conversion similar to the conventional polymer having epoxy group. Concretely, converting to hydroxyl group or introducing sulfone group can be made. A compound having thiol or amine can also be added. Graft chain of the polymer can be structureed by adding the compound having reactive functional group in the terminal, for example, a compound having amino group, which is highly reactive with epoxy group, in the terminal and proceeding the reaction.

Examples of compounds having amino group in the terminal are polyvinylamine, polyethylenimine and amino derivatized polymer such as amino derivatized polysiloxane (amino derivatized silicone oil). Commercially available amino derivatized silicone oil can be used as amino derivatized polysiloxane, which can also be synthesized by the process described in J. Am. Chem. Soc., 78, 2278 (1956). Effect such as improved heat resistance by addition of graft chain to the polymer can be expected.

Recently, a ligand-receptor reaction is widely used as a high sensitive reaction. In the ligand-receptor reaction used herein, a reaction applying various specific binding between the bioactive substance and the receptor such as antigen-antibody reaction, complementarity of nucleic acid; hormone-receptor, enzyme-substrate and biotin-avidin is included. In such reaction, generally, a method comprising binding a ligand or a receptor to a carrier, performing the ligand-receptor reaction, and isolating corresponding receptor or ligand from the medium is used. In particular, a purification method for isolating trace amount of antigen, hormone or nucleic acid having specific sequence in the medium and ligand-receptor assay detecting such substance by applying the reaction are widely used.

The reactive functional group in PHA of the present invention can preferably be used for the carrier of ligand or receptor used for the ligand-receptor reaction, and expression of useful function and properties by the graft polymerization can be utilized.

Other examples of chemical conversion of polymer having epoxy group are crosslinking reaction by diamine compounds such as hexamethylenediamine, succinic anhydride, 2-ethyl-4-methyimidazole and electron beam irradiation. Among them, a reaction with PHA having epoxy group in the side chain and hexamethylenediamine proceeds as shown in the following scheme to form crosslinked polymer.

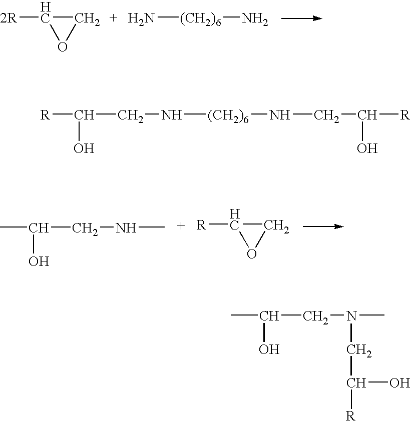

Amount of the base material contained in the structure of the present invention can preferably be selected by considering the usage and required function.

Particle size of the capsule structure in the present invention is selected depending on usage, etc., and is generally 0.02 to 100 μm, preferably 0.05 to 20 μm.

Thickness of the coating membrane of common capsule structure and laminated structure in the present invention is selected depending on usage, etc., and is generally 0.02 to 100 μm, preferably 0.05 to 20 μm.

In an obtained structure, the method of confirming that the base material is coated with a PHA encompasses, for example, a method of the combination of composition analysis by gas chromatography, or the like and form observation by electron microscopy, or the like, and a method of evaluating the structure from mass spectrum of each composition layer using the time-of-flight secondary ion mass spectrometry analysis apparatus (TOF-SIMS) and ion spattering technology. However, as a further direct, simple, easy confirmation method, a method of the combination of Nile Blue A stain and fluorescence microscope observation, which has been newly developed by the present inventors, can be utilized as well. A study of the present inventors on a method of simply and easily confirming PHA synthesis in vitro using a PHA synthase has shown that Nile Blue A, which is a reagent having the property of specifically binding to a PHA to emit fluorescence and which has been reported in Appl. Environ. Microbiol., 44, 238-241 (1982) that Nile Blue A can be used for the simple confirmation of PHA production in a microbe cell in vivo, can also be utilized for the check of PHA synthesis in vitro by setting up appropriate method of use and use conditions, which has completed the aforementioned method. That is, this method can simply check PHA synthesis in vitro, the method that involves filtering a Nile Blue A solution of a specified concentration, admixing the resulting filtrate with a reaction solution containing a PHA, irradiating the mixture with excited light of a given wavelength by a fluorescence microscope and controlling it, and emitting fluorescence only from the synthesized PHA and observing it. As long as a base material used does not emit fluorescence under the aforementioned conditions, a PHA with which the base material surface is coated can be directly observed and. evaluated by applying the aforementioned method to the production of a structure of the present invention.

The composition distribution of a direction from the inner side to the outer side or a vertical direction of PHA coating the base material can be evaluated by a combination of the ion sputtering and the time of flight secondary ion mass spectrograph (TOF-SIMS).

A feature of the present invention has enabled the production of a structure that is difficult to manufacture by an ordinary organic synthetic method. Therefore, the invention can provide a structure having excellent properties that are not exhibited by a capsule structure or laminated structure produced by a conventional organic synthetic process. For example, the invention makes it possible to newly utilize polymeric compounds and provide polymers with new functions and structures, which are difficult to realize by means of conventional organic synthetic approaches. More specifically, new functional polymeric compounds that are difficult to produce by conventional organic synthetic approaches, capsule structures and laminated structures coated with polymeric compounds of extremely high chirality, and the like, can be manufactured by means of extremely simple and easy processes by utilizing extremely precise molecule recognition abilities and stereoselectivity characteristic of catalytic actions of living organisms.

An example of an application of the above described structure is high performance capsule toner for electrophotograph. As explained in above, in the capsule toner for electrophotograph, there are problems that a production process is very complex, and large amount of solvents and surface active agents should be used in the production process. The present invention provides solution of such problems and a method for easy production of capsule toner. Further, a thickness of the outer coating and monomer unit composition can easily be controlled. According to the disclosure of Japanese Patent Application Laid-Open No. H8-286416, effects such as improvement in durability of picture quality, uniformity and stableness of charging can be obtained by admixing polar resin such as polyester in the outer coating of the capsule toner, and the outer coating consisting of PHA in the capsule toner obtained by the method of the present invention can be expected such the effect. Further, in the method of the present invention, since PHA having various functional groups can be used as the outer coating, controlling physical properties of the toner surface and adding novel functionality by an action of such functional groups can possibly be made. Further, except for production process of the core, organic solvent and surface active agent are not used practically or completely in the production process, and in addition, the reaction condition is extremely mild, consequently environmental load in the production can be reduced substantially.

Another example for application of the structure of the present invention includes a recording medium in the inkjet recording method. As described hereinbefore, in a method for forming an ink adsorption layer on the base material in the recording medium, a method by spreading has been conventionally used. The method of the present invention enables production of a new recording medium without using the above method. Namely, by reacting the base material immobilized with enzyme and, for example, 3-hydroxyvinylphenylacyl CoA, wherein R2 is vinyl group in the following chemical formula [10], 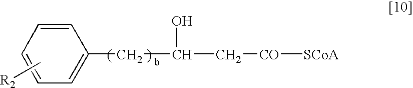
PHA containing the unit of the following chemical formula [2] wherein R2 is vinyl group 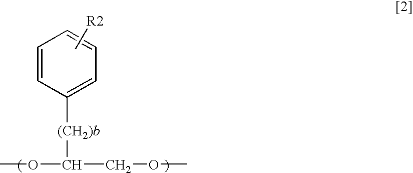
is synthesized, and the recording medium, in which PHA containing the unit wherein R2 is carboxyl group in the above chemical formula [2], i.e. PHA having carboxyl group of the anionic functional group in the side chain is layered over as the ink acceptor layer, can be produced. In the method of the present invention, a production of novel functional recording medium as above, production of which is difficult by conventional method, is made possible.

The structure, method for application and process for production are not limited in above described methods.

### EXAMPLES

The present invention is explained by examples more concretely. Although examples described in the following are one of best mode for carrying out the present invention, the technical scope of the present invention is not limited within these examples. “%” described hereinbelow is weight percent, if otherwise noted.

### Referential Example 1

Preparation of Transformant Having PHA Synthetase Producing Ability.

Strain YN2 was cultured in LB medium (1% polypeptone (Nihon Pharmaceutical Co.), 0.5% yeast extract (Difco Lab.) and 0.5% sodium chloride, pH 7.4) at 30° C. for overnight. Chromosomal DNA was isolated and recovered according to a method by Marmur et. al. The thus obtained chromosomal DNA was completely cleaved by restriction enzyme HindIII. Vector, pUC18 was used and is cleaved by restriction enzyme HindIII. After dephosphorylation of the terminal (Molecular Cloning, 1, 572 (1989); Cold Spring Harbor Laboratory), cloning site of the vector and HindIII cleavage fragment of the chromosomal DNA were ligated by using DNA ligation kit Ver. II (Takara Bio Inc.). Escherichia coli HB101 was transformed by using the plasmid vector integrated with the chromosomal DNA to prepare DNA library of the strain YN2. In order to select DNA fragment containing PHA synthetase gene of the strain YN2, a probe for colony hybridization was prepared. Oligonucleotide consisting of base sequences of SEQ ID NO:2 and SEQ ID NO:3 was synthesized (Amersham Pharmacia Biotech, Inc.), and using this oligonucleotide as a primer, PCR was performed using the chromosomal DNA as a template. DNA fragments amplified by PCR were used as probe. Labeling of the probe was performed by applying commercially available labeling enzyme system, AlkPhosDirect (Amersham Pharmacia Biotech, Inc.). E. coli strain bearing recombinant plasmid containing PHA synthetase was selected from the chromosomal DNA library of the strain YN2 by means of colony hybridization using the obtained labeled probe. The plasmid was recovered from the selected strains by means of alkaline method and DNA fragment containing PHA synthetase gene could be obtained. The thus obtained gene DNA fragment was recombined with a vector pBBR122 (Mo Bi Tec) containing a broad host-range replication region which does not belong any of IncP, IncQ or IncW of the incompatibility group. The recombinant plasmid was transformed to a strain of Pseudomonas cichorii YN2ml (PHA synthesis deficient strain) by means of electroporation. As a result, PHA synthetic ability of the strain YN2ml was reversed to exhibit complementation. Consequently, selected gene DNA fragment was confirmed to contain PHA synthetase gene region, a translational frame to PHA synthetase, in Pseudomonas cichorii YN2ml.

Base sequence of this DNA fragment was determined by means of Sanger method. As a result, in the determined base sequences, existence of the base sequence represented by SEQ ID NO:4 and SEQ ID NO:5, which can encode peptide chains, respectively, was confirmed. Using these PHA synthetase genes, PCR was performed using chromosomal DNA as a template and full length of PHA synthetase was again prepared. The upstream primer (SEQ ID NO:6) and the downstream primer (SEQ ID NO:7) to PHA synthetase gene of the base sequence indicated by SEQ ID NO:4, and the upstream primer (SEQ ID NO:8) and the downstream primer (SEQ ID NO:9) to PHA synthetase gene of the base sequence indicated by SEQ ID NO:5 were synthesized (Amersham Pharmacia Biotech, Inc.).

Using these primers, PCR was performed on base sequences indicated by SEQ ID NO:4 and SEQ ID NO:5 to amplify full length PHA synthetase gene (LA-PCR kit, Takara Bio Inc.). The obtained PCR amplified fragments and expression vector pTrc99A were cleaved by restriction enzyme HindIII, dephosphrylated (Molecular Cloning, Vol. 1, page 572, 1989, Cold Spring Harbor Laboratory), and DNA fragment containing full length of PHA synthetase gene, from which unnecessary base sequences on both ends were deleted, was ligated to the cleavage site of this expression vector pTrc99A by using DNA ligation kit Ver. II (Takara Bio Inc.).

E. coli HB101 (Takara Bio Inc.) was transformed by using the obtained recombinant plasmid with the potassium chloride method. The thus obtained recombinant was cultured and amplified the recombinant plasmid and the recombinant plasmid was recovered. The recombinant plasmid carrying gene DNA of SEQ ID NO:4 was designated as pYN2-C1, and the recombinant plasmid carrying gene DNA of SEQ ID NO:5 was designated as pYN2-C2. E. coli HBlOlfB (fadB deficient strain) was transformed using pYN2-C1 and pYN2-C2 by potassium calcium method to obtain recombinant E. coli strains, pYN2-C1 recombinant strain and pYN2-C2 recombinant strain, each-of which carries corresponding recombinant plasmid.

### Referential Example 2

Production of PHA Synthetase 1

The upstream primer oligonucleotide (SEQ ID NO:10) and the downstream primer oligonucleotide (SEQ ID NO:11) to pYN2-C1 were designed and synthesized (Amersham Pharmacia Biotech, Inc.). PCR was performed using oligonucleotides as the primer and pYN2-C1 as a template to amplify the full length of PHA synthetase gene having BamHI restriction site in the upstream and XhoI restriction site in the downstream (LA-PCR kit, Takara Bio Inc.).

Similarly, the upstream primer oligonucleotide (SEQ ID NO:12) and the downstream primer oligonucleotide (SEQ ID NO:13) to pYN2-C2 were designed and synthesized (Amersham Pharmacia Biotech, Inc.). PCR was performed using oligonucleotides as the primer and pYN2-C2 as a template to amplify the full length of PHA synthetase gene having BamHI restriction site in the upstream and XhoI restriction site in the downstream (LA-PCR kit, Takara Bio Inc.).

Purified each PCR amplified product was digested by BamHI and XhoI and inserted into the corresponding site of the plasmid pGEX-6P-1 (Amersham Pharmacia Biotech, Inc.). E. coli JM109 was transformed by using these vectors to obtain strains for expression. Confirmation of the strain was performed by using DNA fragment, which was obtained by treating the plasmid DNA massively prepared by using Miniprep (Wizard Minipreps DNA Purification Systems, PROMEGA Inc.).

The obtained strain was pre-cultured in LB-Amp medium 10 ml for overnight, and the cultured liquid 0.1 ml was added to LB-Amp medium 10 ml and shake cultured at 37° C., 170 rpm for 3 hours. Thereafter, IPTG was added (final concentration 1 mmol/L) and cultured at 37° C. for 4 to 12 hours.

E. coli induced with IPTG was harvested by centrifugation (78000 m/s² (=8000 G), at 4° C. for 2 min.) and was resuspended in ¼ volume of phosphate buffer saline (PBS: NaCl 8 g, Na₂HPO₄ 1.44 g, KH₂PO_{4 0.24} g, and KCl 0.2 g, purified water 1,000 ml). Microbial cells were disrupted by freeze-thawing and sonication and solid cell debris were removed by centrifugation (78000 m/s² (=8000 G), at 4° C. for 10 min.). After confirming the objective expressed protein in the supernatant by SDS-PAGE, the induced and expressed GST fused protein was purified by using glutathione-Sepharose 4B (Amersham Pharmacia Biotech, Inc.). The glutathione-Sepharose 4B for use was previously treated for suppressing nonspecific adsorption. Namely, after washing the glutathione-Sepharose 4B three times with equivalent volume of PBS (centrifugation at 78000 m/s² (=8000 G) at 4° C. for 1 min.), equal volume of PBS containing with 4% bovine serum albumin was added and treated at 4° C. for 1 hour. After treatment, the glutathione-Sepharose was twice washed with equal volume of PBS and resuspended in ½ volume of PBS. Pretreated the glutathione-Sepharose 40 μl was added to cell-free extract 1 ml and stirred gently at 4° C. According to this treatment, the fused protein GST-YN2-C1 and GST-YN2-C2 were adsorbed to the glutathione-Sepharose. After the adsorption, the glutathione-Sepharose was recovered by centrifugation (at 78000 M/s² (=8000 G) at 4° C. for 1 min.), and washed three times with 400 μl PBS. Thereafter 10 mmol/lit. glutathione 40 μl was added and stirred at 4° C. for 1 hour, then adsorbed fused protein was eluted. The eluate was centrifuged (at 78000 M/s² (=8000 G) at 4° C. for 2 min.). The supernatant was collected and was dialyzed against PBS to purify the GST fused protein. Single band was confirmed by SDS-PAGE.

Each GST fused protein 500 μg was digested by PreScission protease (Amersham Pharmacia Biotech, Inc., 5 U), and passed through the glutathione-Sepharose to remove protease and GST. The flow-through fraction was charged on a column of Sephadex G200 equilibrated with PBS to obtain the expressed protein YN2-C1 and YN2-C2 as final purified products. Single bands at 60.8 kDa and 61.5 kDa were confirmed by SDS-PAGE.

The enzyme was concentrated by using selective adsorbent for concentration of biological fluid (MIZUBUTORIKUN, ATTO Co.) to obtain purified enzyme solution 10 U/ml.

Each purified enzyme was assayed by above described method. Protein concentration in the sample was assayed by using Micro BCA protein assay kit (Pierce Biotechnology, Inc.). Assay results of activities of various enzymes are shown in Table 1.

TABLE 1

| | Specific activity |
|---|---|
| pYN2-C1 | 4.1 U/mg protein |
| pYN2-C2 | 3.6 U/mg protein |

### Referential Example 3

Production of PHA Synthetase 2

A strain P91, strain H45, strain YN2 or strain P161 was inoculated in M9 medium 200 ml containing yeast extract (Difco) 0.5% and octanoic acid 0.1% and shake cultured at 30° C., 125 strokes/min. After 24-hours cultivation, microbial cells were recovered by centrifugation (at 4° C. for 10 min.), resuspended in 0.1 mol/lit. Tris HCl buffer (pH 8.0) 200 ml and again centrifuged for washing. Microbial cells were resuspended in 0.1 mol/lit. Tris HCl buffer (pH 8.0) 2.0 ml, disrupted by using ultrasonic disintegrator and centrifuged (118000 m/s² (=12000 G) at 4° C. for 10 min.), then the supernatant was collected to obtain crude enzyme.

Activity of each purified enzyme was assayed by the previously described method, and results are shown in Table 2.

TABLE 2

| | Activity |
|---|---|
| strain P91 | 0.1 U/ml |
| strain H45 | 0.2 U/ml |
| strain YN2 | 0.4 U/ml |
| strain P161 | 0.2 U/ml |

### Example 1

Preparation of Capsule Structure 1

A mixture of 10 parts by mass of a 10 U/mL solution of PHA synthetase derived from pYN2-C1 recombinant strain, 1 part by mass of alumina particles (particle size: 0.12 to 135 μm) and 39 parts by mass of PBS was mildly shaken at 30° C. for 30 minutes to adsorb the PHA synthetase on the alumina surfaces. The mixture was centrifuged at 98,000 M/s² (10,000 G) and 4° C. for 10 minutes. The resulting precipitate was suspended in a PBS solution and centrifuged again at 98,000 m/s² (10,000 G) and 4° C. for 10 minutes to prepare the immobilized enzyme.

The immobilized enzyme was 'suspended in 48 parts by mass of a 0.1 mol/L phosphate buffer (pH: 7.0). The suspension was incorporated with 1 part by mass of (R)-3-hydroxy-ω-octenoyl-CoA (prepared by the procedure described in Eur. J. Biochem., 250, 432-439 (1997)) and 0.1 parts by mass of bovine serum albumin (Sigma), and mildly shaken at 30° C. for 2 hours.

Next, 10 μL of the above reaction solution was put on a slide glass, mixed with 10μL of a 1% aqueous solution of Nile blue A on the glass and covered with a cover glass, to be observed by a fluorescence microscope (equipped with a 330 to 380 nm excitation filter and 420 nm long-pass filter, Nikon Corp.). It was confirmed that fluorescence was produced on the alumina particle surfaces, by which was meant that the alumina particle surfaces were covered with the PHA.

A control of 49 parts by mass of 0.1 mols/L phosphate buffer (pH: 7.0) incorporated with 1 part by mass of alumina particles was mildly shaken at 30° C. for 2.5 hours. It was stained with Nile blue A in a similar manner to be observed by a fluorescence microscope. It was found that the alumina particle surface produced no fluorescence.

Part of the sample was recovered by centrifugal separation at 98,000 m/s² (10,000 G) and 4° C. for 10 minutes, dried under vacuum, suspended in chloroform, and stirred at 60° C. for 20 hours, to extract PHA serving as a coating. The extract was observed by ¹H-NMR analysis (FT-NMR: Bruker DPx400, analyzed nuclide: ¹H, solvent: deuterated chloroform (with TMS)). It was confirmed that the PHA was composed of the (R)-3-hydroxy-ω-octenoate unit.

Molecular weight of the PHA was determined by gel permeation chromatography (GPC, HLC-8020, Tosoh Corp., column: PLgel MIXED-C (5 μm), Polymer Laboratory, solvent: chloroform, column temperature: 40° C.). It had an Mn of 25, 000 and Mw of 50, 000 as polystyrene conversion.

### Example 2

Preparation of Capsule Structure 2

A mixture of 10 parts by mass of a 10 U/mL solution of PHA synthetase derived from pYN2-C1 recombinant strain, 1 part by mass of alumina particles (particle size: 0.12 to 135 μm) and 39 parts by mass of PBS was mildly shaken at 30° C. for 30 minutes, to adsorb the PHA synthetase on the alumina surfaces. The mixture was centrifuged at 98,000 m/s² (10,000 G) and 4° C. for 10 minutes. The resulting precipitate was suspended in a PBS solution and centrifuged again at 98,00 0 m/s² (10,000 G) and 4° C. for 10 minutes to prepare the immobilized enzyme.

The immobilized enzyme was suspended in 48 parts by mass of a 0.1 mols/L phosphate buffer (pH: 7.0), and the suspension was incorporated with 1 part by mass of (R)-3-hydroxy-3-cyclohexylpropanoyl-CoA (prepared by the procedure described in Eur. J. Biochem., 250, 432-439 (1997)) and 0.1 parts by mass of bovine serum albumin (Sigma), and mildly shaken at 30° C. for 2 hours.

Next, 10 μL of the above reaction solution was put on a slide glass, mixed with 10 μL of a 1% aqueous solution of Nile blue A on the glass and covered with a cover glass to be observed by a fluorescence microscope (equipped with a 330 to 380 nm excitation filter and 420 nm long-pass filter, Nikon Corp.). It was confirmed that fluorescence was produced on the alumina particle surfaces, by which was meant that the alumina particle surfaces were covered with the PHA.

Part of the sample was recovered by centrifugation at 98,000 M/s² (10,000 G) and 4° C. for 10 minutes, dried under vacuum, suspended in chloroform, and stirred at 60° C. for 20 hours, to extract PHA serving as a coating. The extract was observed by ¹H-NMR analysis (FT-NMR: Bruker DPx400, analyzed nuclide: ¹H, solvent: deuterated chloroform (incorporated with TMS)). It was confirmed that the PHA was composed of (R)-3-hydroxy-3-cyclohexylpropinoate unit.

### Example 3

Preparation of Capsule Structure 3

A mixture of 99 parts by mass of crude PHA synthetase derived from YN2, H45, P91 or P161 strain and 1 part by mass of alumina particles (particle size: 0.12 to 135 μm) was mildly shaken at 30° C. for 30 minutes, to adsorb the PHA synthetase on the alumina surfaces. The mixture was centrifuged at 98,000 m/s² (10,000 G) and 4° C. for 10 minutes. The resulting precipitate was suspended in a PBS solution and centrifuged again at 98,000 m/s² (10,000 G) and 4° C. for 10 minutes to prepare the immobilized enzyme.

The immobilized enzyme was suspended in 48 parts by mass of a 0.1 mols/L phosphate buffer (pH: 7.0), and the suspension was incorporated with 1 part by mass of (R)-3-hydroxy-5-phenylmethyloxyvaleryl-CoA (prepared by the procedure described in Eur. J. Biochem., 250, 432-439 (1997)) and 0.1 parts by mass of bovine serum albumin (Sigma), and mildly shaken at 30° C. for 2 hours.

Next, 10 μL of the above reaction solution was put on a slide glass, mixed with 10 μL of a 1% aqueous solution of Nile blue A on the glass and covered with a cover glass to be observed by a fluorescence microscope (equipped with a 330 to 380 nm excitation filter and 420 nm long-pass filter, Nikon Corp.). It was confirmed that fluorescence was produced on the alumina particle surfaces with the reaction solution of each immobilized enzyme, by which was meant that the alumina particle surfaces were covered with the PHA in each run.

Part of the sample was recovered by centrifugation at 98,000 m/s² (10,000 G) and 4° C. for 10 minutes, dried under vacuum, suspended in chloroform, and stirred at 60° C. for 20 hours, to extract PHA serving as a coating. The extract was observed by ¹H-NMR analysis (FT-NMR: Bruker DPx400, analyzed nuclide: ¹H, solvent: deuterated chloroform (with TMS)). It was confirmed that the PHA was composed of the (R)-3-hydroxy-5-phenylmethyloxyvalerate unit.

### Example 4

Preparation of Capsule Structure 4

A mixture of 10 parts by mass of a 10 U/mL solution of PHA synthetase derived from pYN2-C1 recombinant strain, 1 part by mass of alumina particles (particle size: 0.12 to 135 μm) and 39 parts by mass of PBS was mildly shaken at 30° C. for 30 minutes to adsorb the PHA synthetase on the alumina surfaces. The mixture was centrifuged at 98,000 m/s² (10,000 G) and 4° C. for 10 minutes. The resulting precipitate was suspended in a PBS solution and centrifuged again at 98,000 m/s² (10,000 G) and 4° C. for 10 minutes to prepare the immobilized enzyme.

The immobilized enzyme was suspended in 48 parts by mass of a 0.1 mols/L phosphate buffer (pH: 7.0), and the suspension was incorporated with 1 part by mass of (R)-3-hydroxy-5-(4-methylphenyl)valeryl-CoA (prepared by the procedure described in Eur. J. Biochem., 250, 432-439 (1997)) and 0.1 parts by mass of bovine serum albumin (Sigma), and mildly shaken at 30° C. for 2 hours.

Next, 10 μL of the above reaction solution was put on a slide glass, mixed with 10 μL of a 1% aqueous solution of Nile blue A on the glass and covered with a cover glass to be observed by a fluorescence microscope (equipped with a 330 to 380 nm excitation filter and 420 nm long-pass filter, Nikon Corp.). It was confirmed that fluorescence was produced on the alumina particle surfaces with the reaction solution of each immobilized enzyme, by which was meant that the alumina particle surfaces were covered with the PHA in each run.

Part of the sample was recovered by centrifugation at 98,000 m/s² (10,000 G) and 4° C. for 10 minutes, dried under vacuum, suspended in chloroform, and stirred at 60° C. for 20 hours, to extract PHA serving as a coating. The extract was filtered through a membrane filter (pore size: 0.45 μm), concentrated with an rotary evaporator under vacuum, subjected to methanolysis by the common procedure, and analyzed by gas chromatography/mass spectroscopy (GC-MS, QP-5050, Shimadzu Corp., EI method) to identify the methyl esterified product of the PHA monomer unit. It was confirmed that the PHA was composed of the 3-hydroxy-5-(4-methylphenyl)valerate unit.

Molecular weight of the PHA was determined by gel permeation chromatography (GPC, HLC-8020, Tosoh Corp., column: PLgel MIxED-C(5 μm), Polymer Laboratory, solvent: chloroform, column temperature: 40° C.). It had an Mn of 15,000 and Mw of 28,000 as polystyrene conversion.

### Example 5

Preparation of Capsule Structure 5

A mixture of 10 parts by mass of a 10 U/mL solution of PHA synthetase derived from pYN2-C1 recombinant strain; 1 part by mass of alumina particles (particle size: 0.12 to 135 μm) and 39 parts by mass of PBS was mildly shaken at 30° C. for 30 minutes to adsorb the PHA synthetase on the alumina surfaces. The mixture was centrifuged at 98,000 m/s² (10,000 G) and 4° C. for 10 minutes. The resulting precipitate was suspended in a PBS solution and centrifuged again at 98,000 m/s² (10,000 G) and 4° C. for 10 minutes to prepare the immobilized enzyme.

The immobilized enzyme was suspended in 48 parts by mass of a 0.1 mols/L phosphate buffer (pH: 7.0), and the suspension was incorporated with 1 part by mass of (R)-3-hydroxy-5-(4-methylphenoxy)valeryl-CoA (prepared by the procedure described in Eur. J. Biochem., 250, 432-439 (1997)) and 0.1 parts by mass of bovine serum albumin (Sigma), and mildly shaken at 30° C. for 2 hours.

Next, 10 μL of the above reaction solution was put on a slide glass, mixed with 10 μL of a 1% aqueous solution of Nile blue A on the glass and covered with a cover glass to be observed by a fluorescence microscope (equipped with a 330 to 380 nm excitation filter and 420 nm long-pass filter, Nikon Corp.). It was confirmed that fluorescence was produced on the alumina particle surfaces with the reaction solution of each immobilized enzyme, by which was meant that the alumina particle surfaces were covered with the PHA in each run.

Part of the sample was recovered by centrifugation at 98,000 m/s² (10,000 G) and 4° C. for 10 minutes, dried under vacuum, suspended in chloroform, and stirred at 60° C. for 20 hours, to extract PHA serving as a coating. The extract was filtered through a membrane filter (pore size: 0.45 μm), concentrated with an rotary evaporator under vacuum, subjected to methanolysis by the common procedure, and analyzed by gas chromatography/mass spectroscopy (GC-MS, QP-5050, Shimadzu Corp., EI method) to identify the methyl esterified product of the PHA monomer unit. It was confirmed that the PHA was composed of the 3-hydroxy-5-(4-methylphenoxy)valerate unit.

### Example 6

Preparation of Capsule Structure 6

A mixture of 10 parts by mass of a 10 U/mL solution of PHA synthetase derived from pYN2-C1 recombinant strain, 1 part by mass of alumina particles (prepared by a settling method to have a uniform volume-average particle size of 1.45 μm) and 39 parts by mass of PBS was mildly shaken at 30° C. for 30 minutes to adsorb the PHA synthetase on the alumina surfaces. The mixture was centrifuged at 98,000 m/s² (10,000 G) and 4° C. for 10 minutes. The resulting precipitate was suspended in a PBS solution and centrifuged again at 98,000 m/s² (10,000 G) and 4° C. for 10 minutes, to prepare the immobilized enzyme.

The immobilized enzyme was suspended in 48 parts by mass of a 0.1 mols/L phosphate buffer (pH: 7.0), and the suspension was incorporated with 1 part by mass of (R)-3-hydroxy-5-(4-methylphenyl)methylsulfanylvaleryl-COA (prepared by the procedure described in Eur. J. Biochem., 250, 432-439 (1997)) and 0.1 parts by mass of bovine serum albumin (Sigma), and mildly shaken at 30° C. for 2 hours.

Next, 10 μL of the above reaction solution was put on a slide glass, mixed with 10 μL of a 1% aqueous solution of Nile blue A on the glass and covered with a cover glass, to be observed by a fluorescence microscope (equipped with a 330 to 380 nm excitation filter and 420 nm long-pass filter, Nikon Corp.). It was confirmed that fluorescence was produced on the alumina particle surfaces with the reaction solution of each immobilized enzyme, by which was meant that the alumina particle surfaces were covered with the PHA in each run.

Part of the sample was recovered by centrifugation at 98,000 M/s² (10,000 G) and 4° C. for 10 minutes, dried under vacuum, suspended in chloroform, and stirred at 60° C. for 20 hours to extract PHA serving as a coating. The extract was observed by ¹H-NMR analysis (FT-NMR: Bruker DPx400, analyzed nuclide: ¹H, solvent: deuterated chloroform (incorporated with TMS)). It was confirmed that the PHA was composed of the (R)-3-5-(4-methylphenyl)methylsulfanylvalerate unit.

### Example 7

Preparation of Capsule Toner 1

Fine polymer particles which serve the toner core were prepared by the following procedure. A mixture of 710 parts by mass of ion-exchanged water and 450 parts of a 0.1 mols/L aqueous solution of Na₃PO₄ was heated to 60° C. and stirred at 12,000 rpm by a homomixer (TK homomixer, Tokushu Kika Kogyo). Then, it was incorporated with a 1.0 mol/L aqueous solution of CaCl₂ slowly to prepare an aqueous medium containing Ca₃(PO₄)₂. Next, the aqueous medium was incorporated with 165 parts by mass of styrene monomer, 35 parts by mass of n-butyl acrylate, 12 parts of a copper phthalocyanine pigment, 10 parts by mass of an unsaturated polyester (fumaric acid-bisphenol A modified with propylene oxide), 60 parts by mass of an ester wax and 10 parts by mass of 2,2′-azobis(2,4-dimethylvaleronitrile) as a polymerization initiator to be dissolved therein, to prepare a polymerizable monomer composition. The composition was heated to 60° C. and stirred at 12,000 rpm by a homomixer (TK homomixer, Tokushu Kika Kogyo) for uniform dissolution and dispersion. A mixture of the aqueous medium and polymerizable monomer composition was stirred at 10,000 rpm by a homomixer (TK homomixer, Tokushu Kika Kogyo) at 60° C. in an N₂ atmosphere for 10 minutes for granulation. It was heated to 80° C. with stirring by a paddle blade for polymerization for 10 hours. On completion of the polymerization, the resulting polymer suspension was cooled, and incorporated with 3.6 parts by mass of Na₂CO₃ to be kept at pH 11. It was then incorporated, drop by drop, with a polymerizable solution of 82 parts by mass of styrene monomer, 12 parts by mass of n-butyl acrylate, 0.05 parts of an unsaturated polyester (fumaric acid-bisphenol A modified with propylene oxide) and 0.3 parts by mass of potassium persulfate as a polymerization initiator to be dissolved therein. The solution was heated to 80° C. for further polymerization for 6 hours. The mixture was cooled to normal temperature, incorporated with hydrochloric acid to dissolve and remove calcium phosphate, and treated by filtration and drying to prepare the fine particles as the toner core component.

A mixture of 100 parts by mass of a 10 U/mL solution of PHA synthetase derived from pYN2-C1 recombinant strain, 10 part by mass of the fine particles prepared above and 390 parts by mass of PBS was mildly shaken at 30° C. for 30 minutes, to adsorb the PHA synthetase on the fine particle surfaces. The mixture was centrifuged at 98,000 m/s² (10,000 G) and 4° C. for 10 minutes. The resulting precipitate was suspended in a PBS solution and centrifuged again at 98,000 m/s² (10,000 G) and 4° C. for 10 minutes to prepare the immobilized enzyme.

The immobilized enzyme was suspended in 480 parts by mass of a 0.1 mols/L phosphate buffer (pH: 7.0), and the suspension was incorporated with 10 parts by mass of (R)-3-hydroxy-5-phenylthiovaleryl-CoA, which was substituted or not substituted (prepared by the procedure described in Eur. J. Biochem., 250, 432-439 (1997)) and 1 part by mass of bovine serum albumin (Sigma), and mildly shaken at 30° C. for 2 hours.

On completion of the reaction, the mixture was centrifuged at 98,000 m/s² (10,000 G) for 10. minutes. The resulting precipitate was suspended in 1000 parts by mass of a 0.1 mols/L phosphate buffer (pH: 7.0) and then centrifuged again. This procedure was repeated 3 times to recover the precipitate. It was then treated by filtration and drying to produce Capsule Structure A.

Part of Capsule Structure A prepared above was recovered by centrifugation at 98,000 m/s² (10,000 G) and 4° C. for 10 minutes, dried under vacuum, suspended in chloroform, and stirred at 60° C. for 20 hours, to extract PHA serving as a coating. The extract was observed by ¹H-NMR analysis (FT-NMR: Bruker DPx400, analyzed nuclide: ¹H, solvent: deuterated chloroform (incorporated with TMS)). It was confirmed that the PHA was composed of 3-hydroxy-5-phenylthiovaleric acid, which was substituted or not substituted, as the monomer unit.

Next, 10 parts by mass of Capsule Structure A was incorporated in 500 parts by mass of hydrogen peroxide solution (hydrogen peroxide content: 31%, JIS K-8230 product, Mitsubishi Gas Chemical) and 100 parts by mass of deionized water. The mixture, transferred to an egg-plant type flask, was put in an oil bath for reaction at 100° C. for 3 hours. On completion of the reaction, the mixture was cooled, and the capsule structure was centrifuged at 29,400 m/s² (3,000 G) and 4° C. for 30 minutes. The recovered capsule structure was resuspended in distilled water and treated centrifugally again to wash the residual hydrogen peroxide solution. The washing procedure was repeated twice. It was dried under vacuum to prepare Capsule Structure B.

Part of Capsule Structure B prepared above was recovered by centrifugation at 98,000 m/s² (10,000 G) and 4° C. for 10 minutes, dried under vacuum, suspended in chloroform, and stirred at 60° C. for 20 hours, to extract PHA serving as a coating. The extract was observed by ¹H-NMR analysis (FT-NMR: Bruker DPx400, analyzed nuclide: ¹H, solvent: deuterated chloroform (incorporated with TMS)). The calculated composition of the side-chain units comprised 61% of 3-hydroxy-5-phenylsulfonylvaleric acid, 13% of 3-hydroxy-5-phenylsulfinylvaleric acid and 26% of 3-hydroxy-5-phenylsulfonylvaleric acid.

Capsule Toners A and B coated with fine, hydrophobic titanium oxide particles were prepared by incorporating 10 parts by mass of respective Capsule Structures A and B with 0.12 parts by mass of the particles.

Toner C coated with fine, hydrophobic titanium oxide particles was prepared as a control by incorporating 10 parts by mass of the fine core particles described above with 0.12 parts by mass of the titanium oxide particles.

A two-component developer was prepared by mixing 6 parts by mass of each of the above toners with 144 parts by mass of a ferrite carrier coated with an acrylic resin.

Each of the above developers was used to produce images by a commercial copier (NP6000, Canon Inc.) under conditions of 23° C. and 60% RH to evaluate image durability, toner scattering and fogging, among others. The results are given in Table 3. Each of Capsule Toners A and B gave good developers, because the images produced with each of the toners exhibited high durability with no defect, e.g., decreased image density, scattered toner, fogging or the like after 100,000 copies were produced. They also exhibited good charging characteristics, represented by Tribo value. The value was stable, 33 mC/kg before the test and 31 mC/kg after the test. No fixation-related problems were observed. The developer with Toner C, on the other hand, failed to reproduce the original images with high precision, because the images showed defects, e.g., decreased image density, scattered toner, fogging or the like even after 200 copies were produced. It also exhibited uneven, unstable charging characteristics, because its Tribo value was 24 mC/kg before the test and 18 mC/kg after the test. Moreover, the fixation test revealed that it was insufficient in off-setting characteristics at high temperature.

TABLE 3
Table 4

| | | | | Charging | Fixation |
|---|---|---|---|---|---|
| | | Image | Image | character- | character- |
| | Productivity | density | quality | istics | istics |
| Capsule | ∘ | ∘ | ∘ | ∘ | ∘ |
| toner A | | | | | |
| Capsule | ∘ | ∘ | ∘ | ∘ | ∘ |
| toner B | | | | | |
| Toner C | ∘ | < | < | < | < |

Remarks;
∘: Good,
<: Slightly defective,
x: Defective.

Capsule Toners A and B were fixation-tested to evaluate their low-temperature fixation characteristics by an external fixation unit having a fixation structure similar to that in the copier used in the test (NP6000). In the test, an unfixed image was fixed on a 2 cm wide, 10 cm long strip by passing a roller on the strip in the longitudinal direction while monitoring temperature of the upper roller in the external fixation unit. Fixation characteristics of the fixed image were evaluated by observing. whether there was an off-set in the rear end of the strip. It was found that each of Capsule Toners A and B was excellent in low-temperature fixation characteristics, because it showed a low fixation initiation temperature of 95° C.

Capsule Toners A and B were also evaluated for anti-blocking characteristics, where each toner was exposed to a temperature varying at intervals of 1° C. in a range from 50 to 70° C. for 3 days to observe its extent of agglomeration. Then, an image was developed with each toner. Blocking resistance temperature was defined as temperature at which a rough image was produced in the highlighted area. Capsule Toner B had a resistance temperature of 68° C. and Capsule Toner A 57° C., the former having been more excellent in anti-blocking characteristics.

As discussed above, it is found that the toner capsules can realize good low-temperature fixation characteristics when coated with a PHA of low glass transition temperature. The toner capsules coated with a PHA of low glass transition temperature can simultaneously realize good low-temperature fixation and anti-blocking characteristics, when further coated with a PHA of high glass transition temperature, where the PHA molecular structure is transformed by oxidation).

### Example 8

Preparation of Capsule Toner 2

A 3 L four-mouthed separable flask, equipped with a reflux condenser tube, thermometer, nitrogen blowing tube and stirrer, was charged with a mixture of 1200 parts by mass of ion-exchanged water, 15 parts by mass of polyvinyl alcohol, 0.1 parts of sodium dodecylsulfate, 75 parts of styrene monomer, 25 parts of n-butyl acrylate, 5 parts of di-tert-butylsalicylic acid/chromium complex, 5 parts of copper phthalocyanine and 6 parts of 2,2-azobis(2,4-dimethylvaleronitrile). The mixture was stirred by a high-speed stirrer (TK-homomixer) at 10,000 rpm for 10 minutes for granulation, and sufficiently bubbled with nitrogen gas after rotation speed was reduced to 1,000 rpm. It was then heated at 80° C. in an oil bath for 16 hours for polymerization with milder stirring with blade changed to a crescent one.

On completion of the polymerization, the reactor was cooled to room temperature, and the dispersion solution was washed by decantation 5 times, filtered, washed with water and dried to produce the core particles blue. in color. These core particles were used to immobilize PHA synthetase derived from PYN2-c1 recombinant strain in a manner similar to that for EXAMPLE 21.

Next, 10 parts by mass of the immobilized enzyme prepared above was suspended in 480 parts by mass of a 0.1 mols/L phosphate buffer (pH: 7.0), and the suspension was incorporated with 8 parts by mass of (R)-3-hydroxy-5-phenylvaleryl-CoA (prepared by the procedure described in Eur. J. Biochem., 250, 432-439 (1997)), 2 parts by mass of (R)-3-hydroxy-5-(4-vinylphenyl)yvaleryl-CoA (prepared by the procedure described in Eur. J. Biochem., 250, 432-439 (1997)) and 1 part by mass of bovine serum albumin (Sigma), and mildly shaken at 30° C. for 2 hours.

On completion of the reaction, the mixture was centrifuged at 98,000 m/sz (10,000 G) and 4° C. for 10 minutes to recover the capsule structure. It was suspended in 100 parts by mass of refined water 3 times to recover the precipitate. It was Capsule Structure C.

A four-mouthed, round-bottomed flask was charged with 10 parts by mass of Capsule Structure C, which was stirred together with 60 parts by mass of distilled water. Capsule Structure C was heated to 40° C., and reacted with 10 parts by mass of a 30% hexane solution of peracetic acid, continuously dripped into the flask, at 40° C. for 5 hours. The reaction proceeded without agglomerating the capsule Structures each other. On completion of the reaction, the mixture was cooled to room temperature and filtered to recover the capsule structure. It was redispersed in distilled water and centrifuged at 29,400 m/s² (3,000 G) and 4° C. for 10 minutes. The separated capsule structure was redispersed in distilled water and centrifuged again for washing. This procedure was repeated 3 times. The recovered capsule structure was dried under vacuum to prepare intended Capsule Structure D.

Part of the sample was recovered by centrifugation at 98,000 m/s² (10,000 G) and 4° C. for 10 minutes, dried under vacuum, suspended in chloroform, and stirred at 60° C. for 20 hours, to extract PHA serving as a coating. The extract was observed by ¹H-NMR analysis (FT-NMR: Bruker DPx400, analyzed nuclide: ¹H, solvent: deuterated chloroform (with TMS)). The calculated composition of the side-chain units comprised 86% of 3-hydroxy-5-phenylvaleric acid, 10% of 3-hydroxy-5-(4-vinylphenyl)valeric acid and 4% of 3-hydroxy-5-(4-epoxyphenyl)valeric acid.

Next, 10 parts by mass of Capsule Structure D was incorporated with 0.2 parts by mass of hydrophobic, beating-treated silica having a BET surface area of 360 m²/g by Henschel mixer, to prepare Capsule Toner D., Then, 10 parts by mass of Capsule Structure D was suspended in refined water, in which 5 parts by mass of hexamethylenediamine as a crosslinking agent was dissolved. The reaction was allows to proceed at 70° C. for 12 hours, after dissolution of the crosslinking agent was confirmed. On completion of the reaction, the mixture was centrifuged at 98,000 m/s² (10,000 G) and 4° C. for 10 minutes. The precipitate was suspended in 1000 parts by mass of a 0.1 mols/L phosphate buffer (pH: 7.0) and centrifuged again. This procedure was repeated 3 times to recover the precipitate. It was filtered and dried to prepare Capsule Structure E blue in color. Next, 10 parts by mass of Capsule Structure E was incorporated with 0.2 parts by mass of hydrophobic, beating-treated silica having a BET surface area of 360 m²/g by Henschel mixer, to prepare Capsule Toner E.

The image produced by each of the toners prepared above was evaluated. The two-component developer was prepared by incorporating 6 parts by mass of each toner with 94 parts by mass of a silicone-coated carrier with ferrite particles having an average diameter of 35 μm serving as the core, which were mixed by a tubular mixer with stirring. A total of 10,000 copies were produced by a color laser copier (CLC-500, Canon Inc.), which was modified for the test, under conditions of 23° C. and 60% RH. The initial and 10,000th copies were observed by a scanning electron microscope, to evaluate the image quality and deterioration of the developer.

For evaluation of the image quality, multi-valued recording was carried out in each pixel by pulse width modulation, to microscopically observe repeatability of the minimum spots. Moreover, the developer used to produce 10,000 copies was observed by a scanning electron microscope.

For evaluation of anti-blocking characteristics of each toner, it was exposed to a varying temperature for 3 days to observe its extent of agglomeration. Then, an image was developed with each toner composition to evaluate the image quality.

For evaluation of fixation characteristics of each toner, the fixation test was carried out using an external fixation unit having a fixation structure similar to that in CLC-500. In the test, an unfixed image was fixed on a 2 cm wide, 10 cm long strip by passing a roller on the strip in the longitudinal direction while monitoring temperature of the upper roller in the external fixation unit. Fixation characteristics of the fixed image were evaluated by observing whether there was an off-set in the rear end of the strip on the obtained fixed image.

Toner F, which included the as-received core particles (i.e., not capsulated) instead of the capsule structure, was also evaluated by the similar tests. The results are given in Table 4.

TABLE 4
Table 5

| | Image | Anti-blocking | Fixation |
|---|---|---|---|
| | quality | characteristics | characteristics |
| Capsule | T | ◯ | T |
| Toner D | | | |
| Capsule | T | T | T |
| Toner E | | | |
| Toner F | ◯ | ◯ | < |

Remarks;
T: Very good, ◯: Good, <: Slightly defective, x: Defective
(It should be noted that these marks are unrelated to those used for evaluating the toner prepared in EXAMPLE 21).

1. A structure comprising a base material characterized in that the base material is coated at least partly with a polyhydroxyalkanoate containing at least one monomer unit selected from the group consisting of those represented by one of the chemical formulae [1] to [8]: 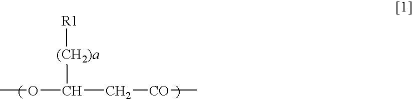
(wherein, the monomer unit is at least one selected from the group consisting of monomer units in which a combination of R1 and “a” is any one of combinations, wherein R1 is vinyl group; and “a” is an integer of 1 to 10), 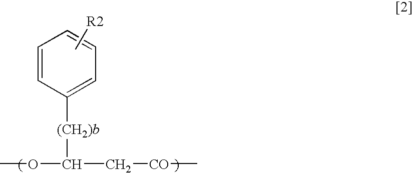
(wherein, “b” is an integer of 1 to 8; and R2 is one selected from the group consisting of CH₃, C₂H₅, C₃H₇, vinyl and epoxy groups, and COOR21 (R21 is H, Na or K atom), which are independently applicable to each unit when there are 2 or more units), 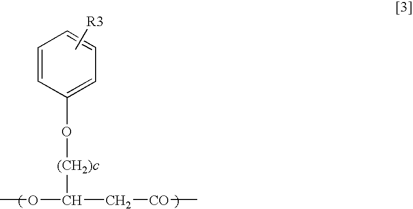
(wherein, “c” is an integer of 1 to 8; and R3 is one selected from the group consisting of CH₃, C₂H₅, C₃H₇ and SCH₃ groups, which are independently applicable to each unit when there are 2 or more units), 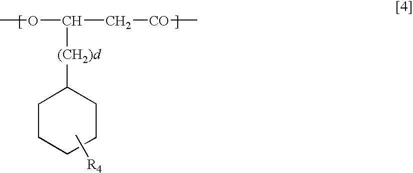
(wherein, “d” is an integer of 0 to 8; and R4 is selected from the group consisting of H and a halogen atoms, and CN, NO₂, CH₃, C₂H₅, C₃H₇, CF₃, C₂F₅ and C₃F₇ groups when “d” is 0, and selected from the group consisting of CH₃, C₂H₅ and C₃H₇ groups when “d” is 1 to 8, which are independently applicable to each unit when there are 2 or more units), 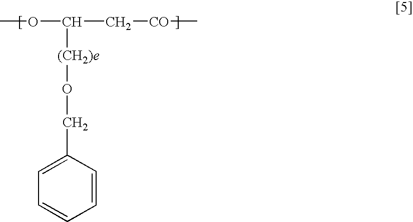
(wherein, “e” is an integer of 1 to 8), 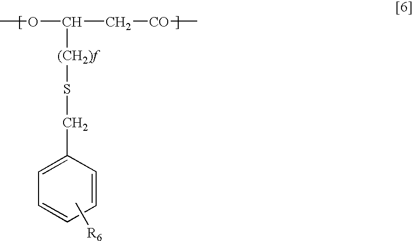
(wherein, “f” is an integer of 1 to 8; and R6 is one selected from the group consisting of CH₃, C₂H₅, C₃H₇, (CH₃)₂—CH and (CH₃)₃—C group, which are independently applicable to each unit when there are 2 or more units), 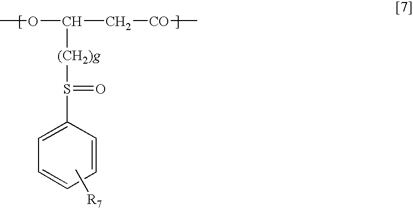
(wherein, “g” is an integer of 1 to 8; and R7 is a H or halogen atom, or CN, NO₂, COOR71 (R71 is H, Na, K, CH₃ or C₂H₅), SO₂R72 (R72 is OH, ONa, OK, a halogen atom, OCH₃ or OC₂H₅), CH₃, C₂H₅, C₃H₇, (CH₃)₂—CH or (CH₃)₃—C group, which are independently applicable to each unit when there are 2 or more units), and 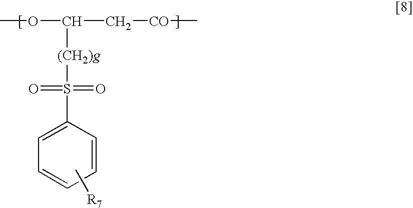
(wherein, “g” is an integer of 1 to 8; and R7 is H or a halogen atom, or CN, NO₂, COOR71 (R71 is H, Na, K, CH₃ or C₂H₅), SO₂R72 (R72 is OH, ONa, OK, a halogen atom, OCH₃ or OC₂H₅), CH₃, C₂H₅, C₃H₇, (CH₃)₂—CH or (CH₃)₃—C group, which are independently applicable to each unit when there are 2 or more units).

2. The structure according to claim 1, wherein the polyhydroxyalkanoate is chemically modified at least partly.

3. The structure according to claim 2, wherein the chemically modified polyhydroxyalkanoate has at least a graft chain.

4. The structure according to claim 3, wherein the graft chain is chemically modified with a polyhydroxyalkanoate which contains a monomer unit having at least one selected from the group consisting of a halogen atom, and vinyl, epoxy and carboxyl groups.

5. The structure according to claim 3, wherein the graft chain is of a compound which has at least one selected from the group consisting of thiol, hydroxyl and amino groups.

6. The structure according to claim 2, wherein the polyhydroxyalkanoate is crosslinked at least partly.

7. The structure according to claim 6, wherein the crosslinked polyhydroxyalkanoate contains a monomer unit having one selected from the group consisting of vinyl and epoxy group.

8. The structure according to claim 1, wherein the base material is particulate.

9. The structure according to claim 8, wherein the base material contains a colorant.

10. A toner which contains the structure according to claim 8.

11. The structure according to claim 1, wherein the base material is in the form of flat plate or film.

12. The structure according to claim 1, wherein the monomer unit composition in the polyhydroxyalkanoate varies from the structure inside towards the outside of the structure.

13. The structure according to claim 1, wherein the base material carries a polyhydroxyalkanoate synthetase immobilized thereon.

14. A method for forming an image by supplying the toner according to claim 10 onto a recording medium.

15. A device for forming an image by supplying the toner according to claim 10 onto a recording medium.

16. A method for producing a structure having a base material coated with a polyhydroxyalkanoate at least partly, comprising the steps of immobilizing an polyhydroxyalkanoate synthetase on the surface of the base material; and polymerizing a 3-hydroxyacyl coenzyme A selected from the group consisting of those represented by one of the chemical formulae [9] to [15] with the aid of the polyhydroxyalkanoate synthetase to synthesize the polyhydroxyalkanoate comprised of a monomer unit selected from the group consisting of those represented by one of the chemical formulae [1] to [8]: 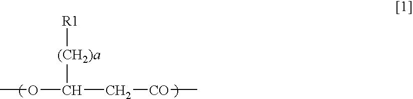
(wherein, the monomer unit is at least one selected from the group consisting of monomer units in which a combination of R1 and “a” is any one of combinations, wherein R1 is vinyl group; and “a” is an integer of 1 to 10), 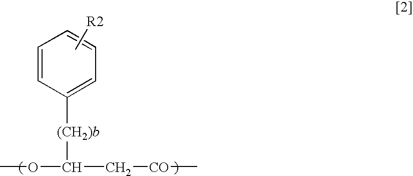
(wherein, “b” is an integer of 1 to 8; and R2 is one selected from the group consisting of CH₃, C₂H₅, C₃H₇, vinyl and epoxy groups, and COOR21 (R21 is H, Na or K atom), which are independently applicable to each unit when there are 2 or more units), 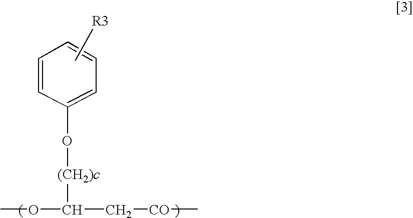
(wherein, “c” is an integer of 1 to 8; and R3 is one selected from the group consisting of CH₃, C₂H₅, C₃H₇ or SCH₃ groups, which are independently applicable to each unit when there are 2 or more units), 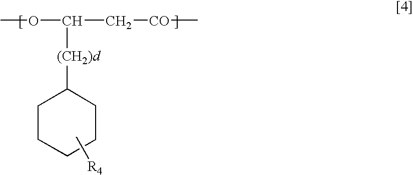
(wherein, “d” is an integer of 0 to 8; and R4 is selected from the group consisting of H and halogen atoms, and CN, NO₂, CH₃, C₂H₅, C₃H₇, CF₃, C₂F₅ and C₃F₇ groups when “d” is 0, and selected from the group consisting of CH₃, C₂H₅ and C₃H₇ groups when “d” is 1 to 8, which are independently applicable to each unit when there are 2 or more units), 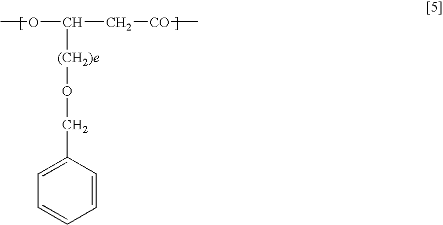
(wherein, “e” is an integer of 1 to 8), 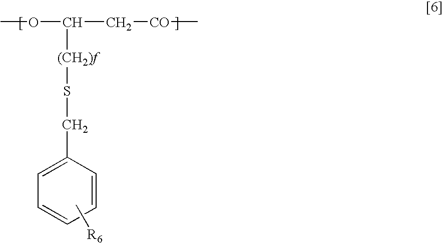
(wherein, “f” is an integer of 1 to 8; and R6 is one selected from the group consisting of CH₃, C₂H₅, C₃H₇, (CH₃)₂—CH and (CH₃)₃—groups, which are independently applicable to each unit when there are 2 or more units), 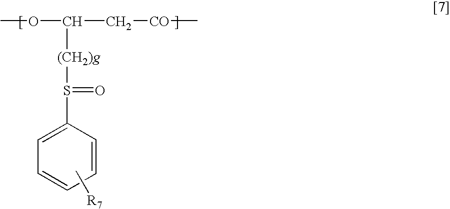
(wherein, “g” is an integer of 1 to 8; and R7 is H or halogen atom, or CN, NO₂, COOR71 (R71 is H, Na, K, CH₃ or C₂H₅), SO₂R72 (R72 is OH, ONa, OK, halogen atom, OCH₃ or OC₂H₅), CH₃, C₂H₅, C₃H₇, (CH₃)₂—CH or (CH₃)₃—C group, which are independently applicable to each unit when there are 2 or more units), 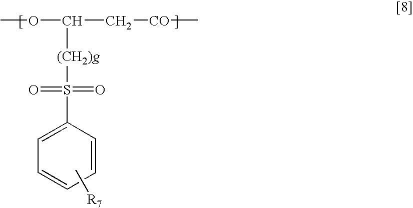
(wherein, “g” is an integer of 1 to 8; and R7 is H or halogen atom, or CN, NO₂, COOR71 (R71 is H, Na, K, CH₃ or C₂H₅), SO₂R72 (R72 is OH, ONa, OK, halogen atom, OCH₃ or OC₂H₅), CH₃, C₂H₅, C₃H₇, (CH₃)₂—CH or (CH₃)₃—C group, which are independently applicable to each unit when there are 2 or more units), 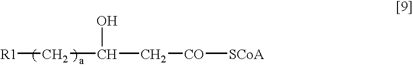
(wherein, —SCoA is a coenzyme A bound to an alkanoic acid; “a” is an integer of 1 to 10, corresponding to “a” in the monomer unit represented by the formula [1]; and R1 is vinyl group), 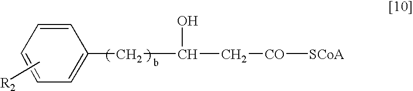
(wherein, —SCoA is a coenzyme A bound to an alkanoic acid; “b” is an integer of 1 to 8, corresponding to “b” in the monomer unit represented by the formula [2]; and R2 is one selected from the group consisting of CH₃, C₂H₅, C₃H₇ and vinyl groups, corresponding to R2 in the monomer unit represented by the formula [2], 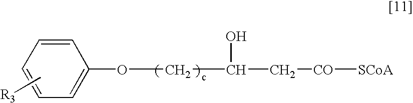
(wherein, —SCoA is a coenzyme A bound to an alkanoic acid; “c” is an integer of 1 to 8, corresponding to “c” in the monomer unit represented by the formula [3]; and R3 is one selected from the group consisting of CH₃, C₂H₅, C₃H₇ and SCH₃ groups, corresponding to R3 in the monomer unit represented by the formula [3], 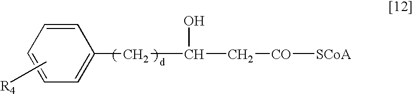
(wherein, —SCoA is a coenzyme A bound to an alkanoic acid; “d” is an integer of 0 to 8, corresponding to “d” in the monomer unit represented by the formula [4]; and R4 is from the group consisting of H and halogen atoms, and CN, NO₂, CH₃, C₂H₅, C₃H₇, CF₃, C₂F₅ and C₃F₇ groups when “d” is 0, and one selected from the group consisting of CH₃, C₂H₅ and C₃H₇ groups when “d” is 1 to 8, corresponding to R4 in the monomer unit represented by the formula [4], 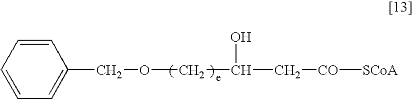
(wherein, —SCoA is a coenzyme A bound to an alkanoic acid; “e” is an integer of 1 to 8, corresponding to “e” in the monomer unit represented by the formula [5], 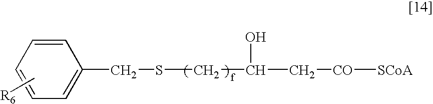
(wherein, —SCoA is a coenzyme A bound to an alkanoic acid; “f” is an integer of 1 to 8, corresponding to “f” in the monomer unit represented by the formula [6]; and R6 is one selected from the group consisting of CH₃, C₂H₅, C₃H₇, (CH₃)₂—CH and (CH₃)₃—C group, corresponding to R6 in the monomer unit represented by the formula [6], and 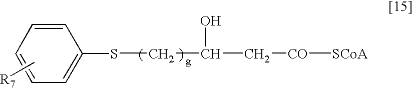
(wherein, —SCoA is a coenzyme A bound to an alkanoic acid; “g” is an integer of 1 to 8, corresponding to “g” in the monomer unit represented by one of the formulae [7] and [8]; and R7 is one selected from the group consisting of H and halogen atoms, and CN, NO₂, COOR71 (R71 is H, Na, K, CH₃ or C₂H₅), SO₂R72 (R72 is OH, ONa, OK, a halogen atom, OCH₃ or OC₂H₅), CH₃, C₂H₅, C₃H₇, (CH₃)₂—CH and (CH₃)₃—C groups, corresponding to R7 in the monomer unit represented by formulae [7] and [8].

17. The method for producing a structure according to claim 16, wherein the monomer unit of polyhydroxyalkanoate coating the base material is oxidized into a monomer unit of different species.

18. The method for producing a structure according to claim 17, wherein the monomer unit to be oxidized is represented by the formula [2] with R2 of vinyl group, and the monomer unit of different species is represented by the formula [2] with R2 of epoxy group or COOR21 (R21 is H, Na or K atom).

19. The method for producing a structure according to claim 17, wherein the monomer unit to be oxidized is represented by the formula [16], and the monomer unit of different species is represented by one of the formulae [7] and [8]: 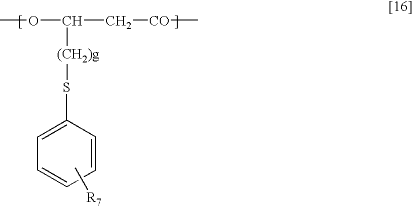
(wherein, “g” is an integer of 1 to 8; and R7 is H or halogen atom, or CN, NO₂, COOR71 (R71 is H, Na, K, CH₃ or C₂H₅), SO₂R72 (R72 is OH, ONa, OK, a halogen atom, OCH₃ or OC₂H₅), CH₃, C₂H₅, C₃H₇, (CH₃)₂—CH or (CH₃)₃—C group, which are independently applicable to each unit when there are 2 or more units).

20. The method for producing a structure according to one of claims 16 to 19, further comprising the step of chemically modifying, at least partly, the polyhydroxyalkanoate coating the base material.

21. The method for producing a structure according to claim 20, wherein the chemical modification step reacts at least part of the polyhydroxyalkanoate with a compound having a reactive functional group at the terminal to add a graft chain to at least part of the polyhydroxyalkanoate.

22. The method for producing a structure according to one of claims 16 to 19, wherein composition of the 3-hydroxyacyl coenzyme A is varied with time to vary the monomer unit composition in the polyhydroxyalkanoate from the inside towards the outside of the structure.

23. A method for producing a toner comprising the step of producing the particulate structure according to one of claims 16 to 19.
